(19) United States
(12) Patent Application Publication
(10) Pub. No.: US 2005/0175101 A1
(43) Pub. Date: Aug. 11, 2005

(54) Apparatus and method for video communication

(76) Inventors: Yoshimasa Honda, Tokyo (JP); Daijiroh Ichimura, Tokyo (JP)

Correspondence Address: NATH & ASSOCIATES, PLLC, Sixth Floor, 1030 15th Street, N.W., Washington, DC, 20005, US

(21) Appl. No.: 11/051,492

(22) Filed: Feb. 7, 2005

(30) Foreign Application Priority Data
Feb. 10, 2004 (JP) 2004-033588
Nov. 25, 2004 (JP) 2004-340972

(51) Int. Cl. H04N 7/12

(52) U.S. Cl. 375/240.16

(57) ABSTRACT

A background separator 120 compares and finds differences between a background image intra-coded in the past and an input image and determines a background area and a non-background area. A base layer coder 130 generates a video stream of a base layer using an input image. An enhancement layer coder 140 actually codes only the image of the non-background area. A video transmitter 160 transmits a video stream of the base layer generated by the base layer coder 130. A video transmitter 170 transmits the video stream of the enhancement layer generated by the enhancement layer coder 140.

### BACKGROUND OF THE INVENTION

1. Field of the Invention

The present invention relates to a video communication apparatus and video communication method.

2. Description of the Related Art

When a coded image is distributed, video data is conventionally compressed/coded to a predetermined bandwidth or below according to the JPEG (Joint Picture Experts Group) scheme, H.261 scheme or MPEG (Moving Picture Experts Group) scheme, etc., so as to be transmittable in the predetermined bandwidth. In the case of the video stream compressed/coded in this way, it is not possible to change parameters such as a bit rate, resolution and frame rate after coding and it is necessary to carry out coding processing a plurality of times according to the band of a network.

On the other hand, standardization of a scalable coding technology for handling band fluctuations on a network is underway in recent years. According to the scalable coding technology, even when a video stream is transmitted using a network such as the Internet whose bandwidth fluctuates, it is possible to freely adjust bandwidths without carrying out coding processing a plurality of times.

Especially, a scalable coding scheme of the MPEG-4 FGS (Fine Granularity Scalability, ISO/IEC 14496-2 Amendment 2) standardized in 2002 carries out layered coding on two types of video stream; base layer and enhancement layer and controls the amount of data of the enhancement layer, and can thereby play images of quality (e.g., PSNR, frame rate) corresponding to the bandwidth of the network. Even when the enhancement layer is divided into small portions of data having an arbitrary amount of data, the image can be played, and therefore the MPEG-4 FGS features adaptability to all bandwidths of the network. Such a feature is called “fine granularity scalability (FGS).”

The fine granularity scalable coding scheme such as the MPEG-4 FGS has a structure whereby the amount of data per frame is variable to quickly respond to fluctuations in the bandwidth. Therefore, the enhancement layer is coded based on an intra-frame coding scheme which does not utilize any correlation between succesive frames. The intra-frame coding scheme generally has a limit in improvement of coding efficiency, and therefore the fine granularity scalable coding scheme has poor coding efficiency of enhancement layer.

Thus, in order to improve the coding efficiency, applying inter-frame prediction coding to an enhancement layer is under study. That is, for example, Non-Patent Document 1 (ISO/IEC/SC29/WG11 MPEG99/m5583) discloses that inter-frame prediction coding is carried out in an enhancement layer using a preceding enhancement layer decoded image as a reference image to improve coding efficiency.

More specifically, when an input image is layered-coded, the Non-Patent Document 1 discloses an invention that codes the enhancement layer and improves the coding efficiency by applying inter-frame prediction coding of searching for an area where there is a high correlation between a reference image which is the decoded image of the preceding enhancement layer and input image and carrying out difference processing between both images.

However, carrying out inter-frame prediction coding requires decoding processing on an enhancement layer and motion vector search processing, which increases the processing load and produces delays compared to the intra-frame coding scheme.

In order to improve this point, the Patent Document 1 (Unexamined Japanese Patent Publication No. 10-224799) discloses an invention that predicts movement using a motion vector of a base layer in coding an enhancement layer and reduces an amount of processing of motion vector search required for inter-frame prediction coding of the enhancement layer.

However, the above described conventional technology has a problem that when the data transmitting side changes the amount of data of the enhancement layer, the data receiving side cannot decode the reference image used during coding correctly, producing a decoding error in inter-frame prediction.

That is, as described above, the fine granularity scalable coding scheme adopts a structure whereby the amount of data per frame is variable and if the data transmitting side changes the data amount of an enhancement layer according to fluctuations in the bandwidth, the data amount of the enhancement layer received on the data receiving side is not constant. When the data receiving side carries out decoding on an enhancement layer, if the data amount is not constant, it is not possible to correctly decode a reference image which is a decoded image of the preceding enhancement layer used during coding.

Therefore, inter-frame prediction is not correctly carried out and it is not possible to obtain a decoded image of an enhancement layer from the received data. Such a situation also occurs when a packet loss, etc., occurs on a network and the data amount of the received enhancement layer fluctuates.

Furthermore, in inter-frame prediction coding, when a decoding error occurs in a certain intra-frame, the decoding error gives quality detetoriation to the following frames and propagated (drift noise), and therefore once a decoding error occurs, the subsequent decoding is no longer carried out correctly.

### SUMMARY OF THE INVENTION

The present invention has been implemented in view of the problems described above and it is an object of the present invention to provide a video communication apparatus and video communication method capable of improving coding efficiency while suppressing processing load without producing drift noise.

According to an aspect of the invention, a video communication apparatus of the present invention comprises a separator separate an input image into a background area and a non-background area, a coder codes the separated non-background area and a transmitter transmits a video stream of the non-background area obtained through coding.

According to another aspect of the invention, a video communication apparatus of the present invention comprises a receiver receives a video stream of a non-background area, a decoder decodes the received video stream and a combiner combines the image of the non-background area obtained through decoding from the received video stream and a prestored background image.

According to a further aspect of the invention, the video communication method of the present invention comprises receiver receives a video stream of a non-background area, a decoder decodes the received video stream and a combiner discriminates between a background area and a non-background area based on a base layer decoded image obtained through decoding from the received video stream and background image decoded from the received video stream and prestored and combines the image of the non-background area obtained through decoding and the background area of the prestored background image based on the discrimination result.

According to a still further aspect of the invention, a video communication method of the present invention comprises the steps of separating an input image into a background area and non-background area, coding only the separated non-background area and sending the video stream of the non-background area obtained through coding.

According to a still further aspect of the invention, a video communication method of the present invention comprises the steps of receiving a video stream of a non-background area, decoding the received video stream and combining the image of the non-background area obtained through decoding and a prestored background image.

### BRIEF DESCRIPTION OF THE DRAWINGS

The above and other objects and features of the invention will appear more fully hereinafter from a consideration of the following description taken in connection with the accompanying drawing wherein examples are illustrated by way of example, in which;

FIG. 1 is a block diagram showing the configuration of a video transmission apparatus according to Embodiment 1 of the present invention;

FIG. 2 is a block diagram showing the configuration of the video reception apparatus according to Embodiment 1;

FIG. 3 is a flow chart showing the operation of the video transmission apparatus according to Embodiment 1;

FIG. 4 is a flow chart showing background discrimination processing of the video transmission apparatus according to Embodiment 1;

FIG. 5A illustrates an example of an input image at a time t;

FIG. 5B illustrates an example of the input image at a time (t+1);

FIG. 5C illustrates a non-background area at a time (t+1);

FIG. 6A illustrates an example of a non-background area;

FIG. 6B illustrates an example of a non-background map;

FIG. 7A illustrates another example of the non-background area;

FIG. 7B illustrates another example of the non-background map;

FIG. 8 is a flow chart showing the operation of a video reception apparatus according to Embodiment 1;

FIG. 9 is a flow chart showing background combination processing of the video reception apparatus according to Embodiment 1;

FIG. 10A illustrates an example of a background area;

FIG. 10B illustrates an example of a non-background area;

FIG. 10C illustrates a combined image;

FIG. 11 is a block diagram showing the configuration of a video transmission apparatus according to Embodiment 2 of the present invention;

FIG. 12 is a block diagram showing the configuration of a video reception apparatus according to Embodiment 2;

FIG. 13 is a flow chart showing background discrimination processing of the video transmission apparatus according to Embodiment 2;

FIG. 14A illustrates an example of a background image;

FIG. 14B illustrates an example of the input image;

FIG. 14C illustrates an example of the background image after movement;

FIG. 14D illustrates a non-background area;

FIG. 15A illustrates an example of a non-background area;

FIG. 15B illustrates an example of background information;

FIG. 16 is a flow chart showing background combination processing of the video reception apparatus according to Embodiment 2;

FIG. 17A illustrates an example of a background area;

FIG. 17B illustrates an example of a non-background area;

FIG. 17C illustrates a combined image;

FIG. 18 is a block diagram showing the configuration of a video transmission apparatus according to Embodiment 3 of the present invention;

FIG. 19 is a block diagram showing the configuration of a video reception apparatus according to Embodiment 3;

FIG. 20 is a flow chart showing the operation of the video transmission apparatus according to Embodiment 3;

FIG. 21 is flow chart showing background discrimination processing at a background separator according to Embodiment 3;

FIG. 22 is flow chart showing the operation of the video reception apparatus according to Embodiment 3; and

FIG. 23 is a flow chart showing background combination processing of a background combiner according to Embodiment 3.

### DETAILED DESCRIPTION OF THE PREFERRED EMBODIMENTS

According to this embodiment of the present invention, a video transmitting side compares input video with preceding input video stored as a background image, codes and sends only a changed area and a video receiving side receives only the changed area and combines the area with the same background image as that on the transmitting side.

With reference now to the attached drawings, embodiments of the present invention will be explained in detail below. The embodiment below will explain a case where the MPEG-4 FGS is used as a coding scheme for input video. A video stream coded by the MPEG-4 FGS is constructed of a base layer which can be decoded as a single unit and an enhancement layer for improving the quality of a decoded moving image of the base layer. With the only base layer transmittion, it can realize the video stransmittion through a low bit rate network, but can only obtain video data of low quality. However, by transmitting and adding up enhancement layers according to available bandwidth and thereby realize high quality with a high degree of freedom.

The video coding scheme to which the present invention is applied is not limited to the MPEG-4 FGS and the present invention is applicable to various types of coding scheme if it is at least a fine granularity scalable coding scheme such as JPEG2000.

### Embodiment 1

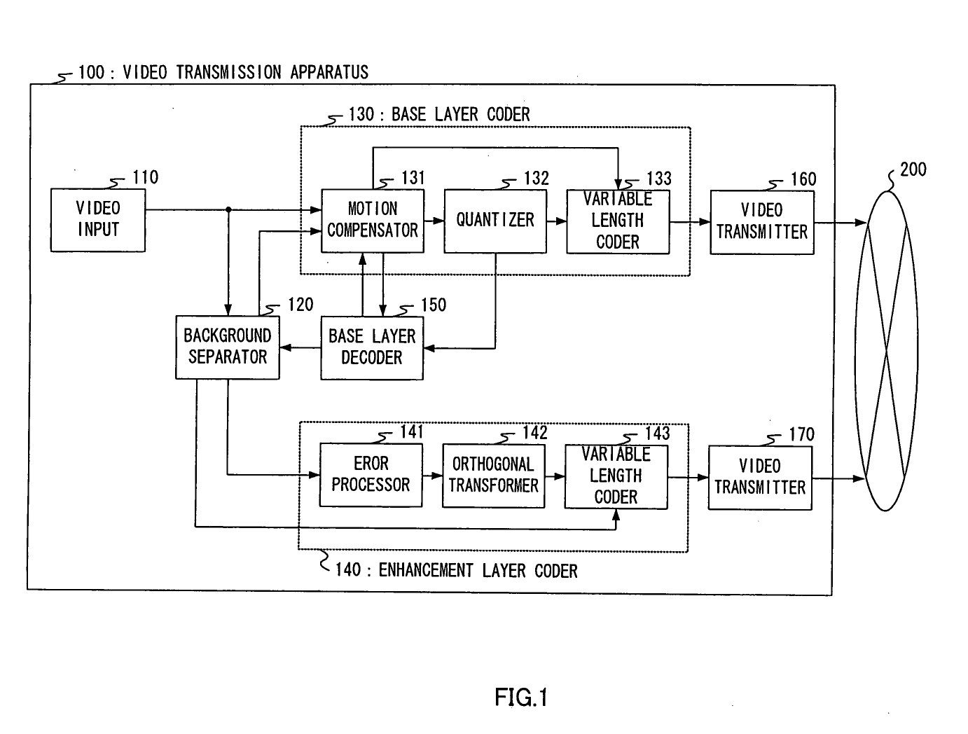

FIG. 1 is a block diagram showing the configuration of a video transmission apparatus according to Embodiment 1 of the present invention. The video transmission apparatus 100 shown in FIG. 1 is provided with a video input 110, a background separator 120, a base layer coder 130, an enhancement layer coder 140, a base layer decoder 150, a video transmitter 160 and a video transmitter 170.

The video input 110 receives video through an imaging device such as a surveillance camera and outputs images making up the input image to the base layer coder 130 and the enhancement layer coder 140 image by image.

The background separator 120 compares and finds differences between the input image and a background image coded in the past within a frame (hereinafter referred to as “intra-coding”) without using a correlation between the preceding and following frames and determines a background area which is an area where pixel values are not changed and other non-background area for each macro block made up of 16×16 pixels. Therefore, the background area is an area having the same pixel values as those of the past intra-coded background image and the non-background area is an area having pixel values different from those of the past intra-coded background image.

The intra-coded image is an image coded without using a correlation between frames, and therefore it is inferior in coding efficiency compared to an image subjected to non-intra-coding, that is, inter-coding which realizes coding using a correlation between frames, but intra-coding can decode an image as a single image (frame) and can thereby improve error resistance and improve random accessibility.

Furthermore, the background separator 120 replaces the pixel values of the background area in the input image and decoded image of the base layer (hereinafter referred to as “reference image”) generated by the base layer decoder 150 with zeros and outputs the resultant values to a error processor 141 in the enhancement layer coder 140.

Furthermore, the background separator 120 generates background information indicating whether each macro block is a background area or not and outputs the background information to a variable length coder 143 in the enhancement layer coder 140. Furthermore, the background separator 120 decides a coding mode as to whether or not carry out intra-coding, outputs coding mode information to a motion compensator 131 in the base layer coder 130 and stores, when the coding mode is intra-coding, the input image as a background image.

The base layer coder 130 generates a video stream of the base layer using the entire area of the input image. More specifically, the base layer coder 130 includes the motion compensator 131, a quantizer 132 and a variable length coder 133, and these processing sections perform the following operations.

The motion compensator 131 performs motion prediction processing for calculating the position at which the correlation between these images becomes highest in macro block units using the input image from the video input 110 and reference image output from the base layer decoder 150. Furthermore, the motion compensator 131 calculates a vector indicating a relative position having the highest correlation (hereinafter referred to as “motion vector”), outputs the motion vector to the variable length coder 133 and base layer decoder 150, calculates a difference pixel by pixel at the position with the highest correlation to thereby perform motion compensation processing for generating an error image and outputs the error image to the quantizer 132. Furthermore, the motion compensator 131 notifies the coding mode information from the background separator 120 to the variable length coder 133 and base layer decoder 150.

The above described motion prediction processing is not performed on the first input image when coding processing is started, input image at predetermined image intervals and input image when the coding mode is intra-coding, and the input image itself is output to the quantizer 132.

The quantizer 132 carries out the DCT (Discrete Cosine Transform) transform which is a kind of orthogonal transform on the error image or input image itself output from the motion compensator 131 and replaces the obtained coefficients with the quotient obtained by dividing the coefficients by a predetermined quantized value (hereinafter referred to as “orthogonal transform coefficients”). At this time, the quantizer 132 DCT-transforms the error image (or input image itself) in units of a block made up of 8×8 pixels. The quantizer 132 may also be adapted so as to perform the orthogonal transform on an error image using the Wavelet transform, etc., used in JPEG2000, etc., instead of the DCT transform.

The variable length coder 133 carries out variable length coding processing on the motion vector and coding mode information output from the motion compensator 131 and quantized orthogonal transform coefficients output from the quantizer 132 using a variable length coding table and outputs the video stream of the base layer obtained to the video transmitter 160. At this time, when the coding mode is intra-coding, the variable length coder 133 has not performed any motion compensation prediction processing, and therefore performs variable length coding processing on only the coding mode information and orthogonal transform coefficients. The method of variable length coding processing by the variable length coder 133 is not limited to the method using the variable length coding table and can be any method for transforming the orthogonal transform coefficients to a two-value code string.

The enhancement layer coder 140 generates a video stream of an enhancement layer using an image with pixel values of the background area replaced by zeros output from the background separator 120. That is, the enhancement layer coder 140 actually codes only the image of the non-background area. More specifically, the enhancement layer coder 140 includes the error processor 141, an orthogonal transformer 142 and the variable length coder 143 and these processors perform the following operations.

The error processor 141 carries out difference processing between the input image with pixel values of the background area output from the background separator 120 replaced with zeros and a reference image, generates an error image and outputs the error image to the orthogonal transformer 142.

The orthogonal transformer 142 carries out the DCT transform on the error image output from the error processor 141 block by block and outputs the converted orthogonal transform coefficients to the variable length coder 143.

The variable length coder 143 carries out variable length coding processing on the orthogonal transform coefficients for each bit plane using the variable length coding table and outputs the video stream of the enhancement layer obtained to the video transmitter 170. Furthermore, the variable length coder 143 carries out variable length coding processing on the background information output from the background separator 120 indicating whether each macro block is a background area or not and outputs the background information to the video transmitter 170.

The base layer decoder 150 carries out inverse quantization and inverse orthogonal transform processing on the orthogonal transform coefficients output from the quantizer 132 and decodes the error image. Furthermore, the base layer decoder 150 carries out addition processing on the reference image used at the motion compensator 131 and error image using the preceding decoded image and motion vector output from the motion compensator 131 and thereby generates a reference image which is a new decoded image.

The video transmitter 160 sends the video stream of the base layer generated by the base layer coder 130 and coding mode information to the user over a network 200.

The video transmitter 170 sends the video stream and background information of the enhancement layer generated by the enhancement layer coder 140 to the user via the network 200.

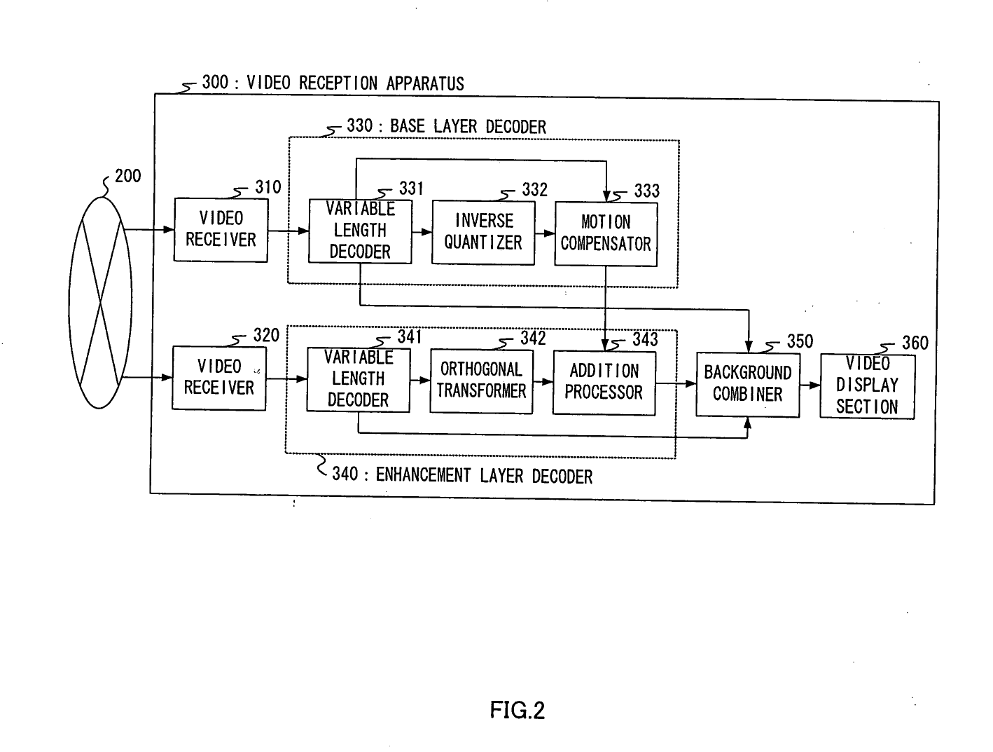

FIG. 2 is a block diagram showing the configuration of a video reception apparatus according to Embodiment 1. The video reception apparatus 300 shown in FIG. 2 includes a video receiver 310, a video receiver 320, a base layer decoder 330, an enhancement layer decoder 340, a background combiner 350 and a video display section 360.

The video receiver 310 receives the video stream and coding mode information of the base layer from the network 200 and outputs the video stream and coding mode information to the base layer decoder 330.

The video receiver 320 receives the video stream and background information of the enhancement layer from the network 200 and outputs the video stream and background information to the enhancement layer decoder 340.

The base layer decoder 330 generates a decoded image of the base layer from the video stream of the base layer output from the video receiver 310. More specifically, the base layer decoder 330 includes a variable length decoder 331, an inverse quantizer 332 and a motion compensator 333 and these processors perform the following operations.

The variable length decoder 331 variable-length-decodes the output from the video receiver 310, decodes the orthogonal transform coefficients, motion vector and coding mode information, outputs the orthogonal transform coefficients to the inverse quantizer 332, outputs the motion vector to the motion compensator 333 and outputs the coding mode information to the background combiner 350.

The inverse quantizer 332 carries out inverse quantization processing and inverse orthogonal transform processing on the orthogonal transform coefficients output from the variable length decoder 331 and decodes an error image.

The motion compensator 333 generates a new decoded image using the error image output from the inverse quantizer 332, motion vector output from the variable length decoder 331 and the stored decoded image.

The enhancement layer decoder 340 generates a decoded image of the enhancement layer from the video stream of the enhancement layer output from the video receiver 320. More specifically, the enhancement layer decoder 340 is provided with a variable length decoder 341, an orthogonal transformer 342 and an addition processor 343 and these processors perform the following operations.

The variable length decoder 341 carries out variable length decoding processing on the output from the video receiver 320, decodes orthogonal transform coefficients and background information scanned block by block for each bit plane, outputs the orthogonal transform coefficients to the orthogonal transformer 342 and outputs the background information to the background combiner 350.

The orthogonal transformer 342 carries out the inverse DCT transform on the orthogonal transform coefficients output from the variable length decoder 341 and decodes an error image.

The addition processor 343 carries out addition processing on the decoded image of the base layer output from the motion compensator 333 and the error image output from the orthogonal transformer 342 and outputs the obtained decoded image to the background combiner 350.

The background combiner 350 generates an image according to the coding mode information or background information using the decoded image obtained by the addition processor 343 and prestored background image. That is, the background combiner 350 combines the background area of the background image and the non-background area of the decoded image according to the background information and outputs the combined image to the video display section 360 on one hand and stores the decoded image as a new background image on the other when the coding mode is intra-coding.

The video display section 360 displays the combined image or decoded image on a display device, etc.

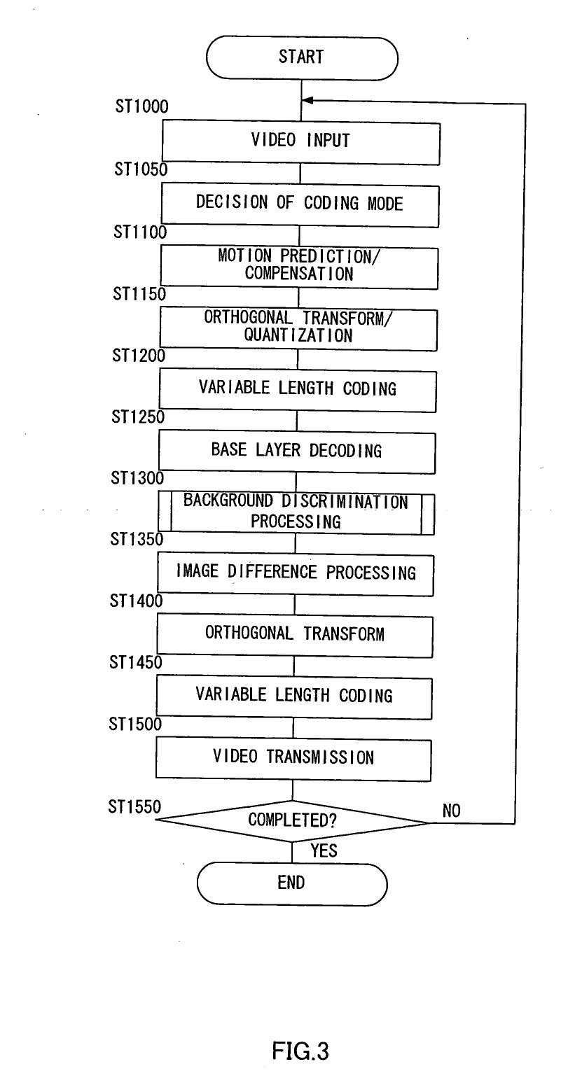

Next, the operation of the video transmission apparatus 100 in the above described configuration will be explained using the flow chart shown in FIG. 3. The operation of the flow chart shown in FIG. 3 is stored as a control program in a storage device (not shown) (e.g., ROM or flash memory) of the video transmission apparatus 100 and controlled by a CPU (not shown).

First, the video input 110 inputs video (ST1000) More specifically, the video input 110 having an imaging element such as a surveillance camera inputs video and outputs images constituting the input video to the motion compensator 131 and background separator 120 image by image.

Then, the background separator 120 decides whether the coding mode of the input image is intra-coding or not (ST1050) and outputs coding mode information indicating whether the coding mode is intra-coding or not to the motion compensator 131. The coding mode is decided as intra-coding when a number of images exceeding a predetermined threshold TH1 are coded after preceding intra-coding is carried out or when the proportion of the non-background area in the input image exceeds a predetermined threshold TH2 and decided as non-intra-coding otherwise. The predetermined thresholds TH1, TH2 are preset values and set, for example, as TH1=30, TH2=0.5.

When the coding mode information is output to the motion compensator 131, the input image and the reference image output from the base layer decoder 150 are used through the motion prediction processing by the motion compensator 131 and the position corresponding to the highest correlation between the input image and reference image is calculated. Furthermore, through pixel-by-pixel difference processing between the reference image and input image based on the motion vector indicating this position, an error image is calculated through the motion compensation processing (ST1100). The error image calculated in ST1100 is output to the quantizer 132 and the coding mode information output from the motion vector and background separator 120 are output to the variable length coder 133 and base layer decoder 150.

Then, the quantizer 132 DCT-transforms and quantizes the error image block by block (ST1150). The orthogonal transform coefficients after quantization processing is output to the variable length coder 133 and base layer decoder 150. As described above, the orthogonal transform at the quantizer 132 is not limited to the DCT transform and may also be the Wavelet transform, etc.

Then, the variable length coder 133 carries out variable length coding on the motion vector and coding mode information output from the motion compensator 131 and orthogonal transform coefficients output from the quantizer 132 (ST1200) and outputs the video stream of the base layer and coding mode information obtained to the video transmitter 160.

Thus, the base layer coder 130 generates a video stream of the base layer on one hand and the base layer decoder 150 generates a decoded image of the base layer on the other (ST1250). That is, the base layer decoder 150 inverse-quantizes and inverse-orthogonal-transforms the orthogonal transform coefficients output from the quantizer 132 and decodes the error image. Furthermore, using the reference image and motion vector used by the motion compensator 131, addition processing is carried out on the reference image and error image and a new decoded image is generated. This decoded image is output to the motion compensator 131 and background separator 120.

When it is decided based on the coding mode information output from the motion compensator 131 that the coding mode is intra-coding, no addition processing is performed on the reference image and error image. In other words, the result of the inverse quantization and inverse orthogonal transform of the orthogonal transform coefficients output from the quantizer 132 become a new decoded image.

Then, the background separator 120 carries out background discrimination processing (ST1300). More specifically, the background separator 120 separates the background area from the non-background area in the input image in macro block units and background information indicating whether each macro block is a background area or not is generated. The background information generated is output to the variable length coder 143. Furthermore, the background separator 120 replaces pixel values of the input image and background area of the reference image with zeros and outputs the values to the error processor 141. The background discrimination processing of the background separator 120 will be explained in detail later.

When an image whose background area has been replaced by zeros is output, the error processor 141 carries out difference processing between the input image and reference image (ST1350) and outputs the error image obtained to the orthogonal transformer 142. Here, since the pixel values of the background area of the input image and reference image have been replaced with zeros, the error image obtained by the error processor 141 is an image having meaningful pixel values only in the non-background area.

Then, the orthogonal transformer 142 performs the DCT transform on the error image block by block (ST1400) and outputs the orthogonal transform coefficients obtained to the variable length coder 143.

Then, the variable length coder 143 carries out variable length coding on the orthogonal transform coefficients and background information per bit plane output from the orthogonal transformer 142 (ST1450) and the video stream and background information of the enhancement layer obtained are output to the video transmitter 170.

When the video stream and coding mode information of the base layer are output to the video transmitter 160 and the video stream and background information of the enhancement layer are output to the video transmitter 170, the video stream, coding mode information and background information are sent from the video transmitter 160 and video transmitter 170 to the network 200 (ST1500). After the transmission, it is decided whether conditions for completing the processing are satisfied or not (ST1550), and the processing is completed when the conditions are satisfied, whereas the processing is repeated from ST1000 when the conditions are not satisfied.

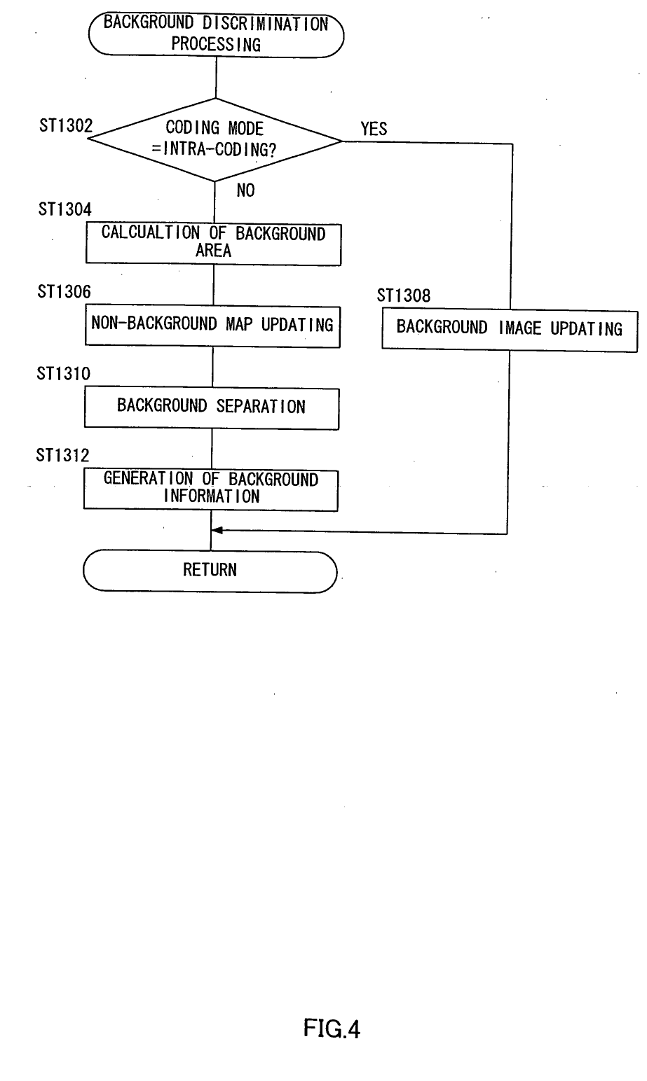

Next, the background discrimination processing of the above described video transmission apparatus 100 will be explained with a specific example and using a flow chart in FIG. 4.

First, the background separator 120 decides whether the coding mode is intra-coding or not as a result of the coding mode decision in ST1050 in FIG. 3 (ST1302).

When the result of this decision shows that the coding mode is intra-coding (ST1302 “YES”), the background image is updated (ST1308). That is, the background separator 120 stores the input image as a new background image. As described above, when a predetermined number of images are input or the proportion of the non-background area in the input image is large after the preceding background image is updated, that is, intra-coding is performed, the coding mode becomes intra-coding, and therefore it is possible to minimize the following non-background area by updating the background image at this time. As a result, it is possible to increase the background area of the error image to be coded thereafter whose pixel values become zeros, reduce the actually coded area and improve the coding efficiency.

Furthermore, if it is decided that the coding mode is intra-coding (ST1302 “YES”), when the background separator 120 creates a non-background map which shows the background area as “1” and non-background area as “0” for each macro block, all the macro blocks are initialized by “1” (that is, background area).

On the other hand, when the decision result in ST1302 shows that the coding mode is not intra-coding, that is, it is decided that the coding mode is non-intra-coding such as inter-coding using temporal prediction with other frames (ST1302 “No”), the background separator 120 carries out difference processing between the input image and preceding background image for each macro block and macro blocks whose sum of absolute values of difference values of pixels in the macro block is equal to or lower than a threshold are regarded as background areas and other macro blocks are regarded as non-background areas (ST1304). Here, the preceding background image refers to a background image stored in the background separator 120 when the preceding coding mode is intra-coding.

Furthermore, when the coding mode is decided to be non-intra-coding (ST1302 “No”), the background separator 120 updates the macro block of the non-background area in the non-background map to “0” (ST1306).

Then, the background separator 120 separates the background area from the non-background area in the input image and reference image (ST1310), replaces pixel values of the background area in both images by zeros and outputs the values to the error processor 141.

Furthermore, background information is generated with a predetermined header such as an image number added to the non-background map updated in ST1306 (ST1312) and output to the variable length coder 143.

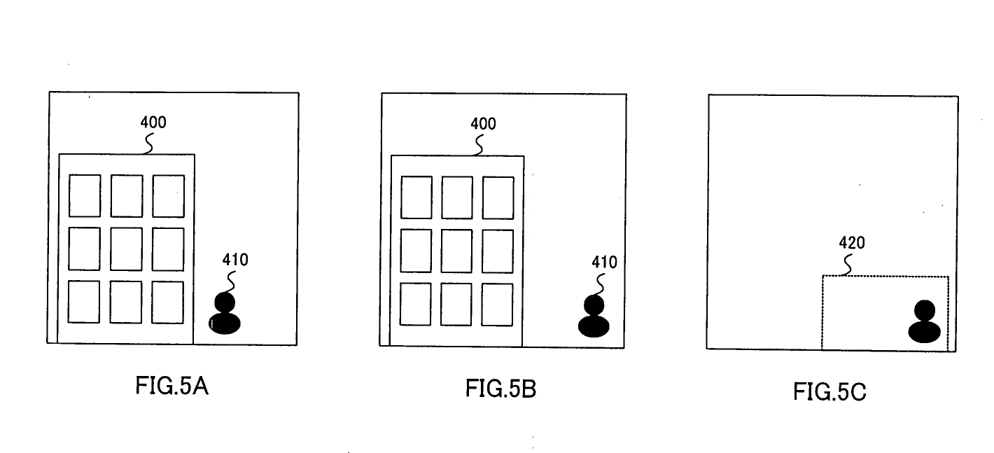

A specific example of the background discrimination processing will be shown below using FIG. 5 to FIG. 7.

Suppose FIG. 5A shows an input image at a time t and FIG. 5B shows an input image at a time (t+1). As is evident from these figures, while an object 400 is stationary without moving from the time t to time (t+1), an object 410 has moved. In such a case, at the time (t+1), the image shown in FIG. 5A is output to the background separator 120 as a reference image. Therefore, the background separator 120 carries out difference processing between the input image (FIG. 5B) and reference image (FIG. 5A) at the time (t+1), and as a result, the area including the object 400 becomes a background area and the area 420 including the position of the object 410 at the time t and time (t+1) shown in FIG. 5C becomes a non-background area.

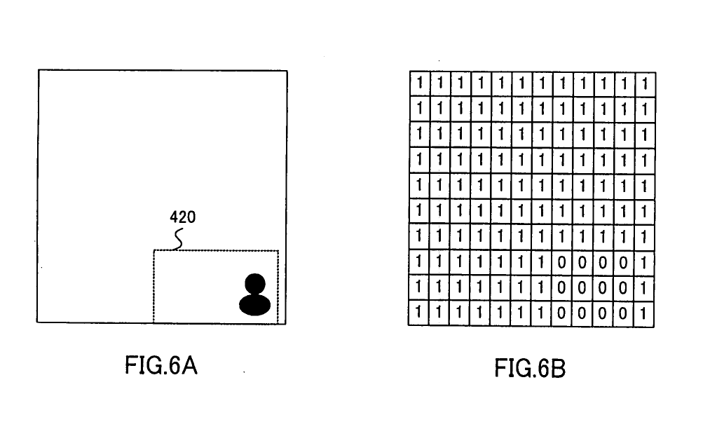

Then, the pixel values other than the area 420 shown in FIG. 6A are replaced by zeros and a non-background map is created as shown in FIG. 6B with the area 420 updated to “0” indicating the non-background area.

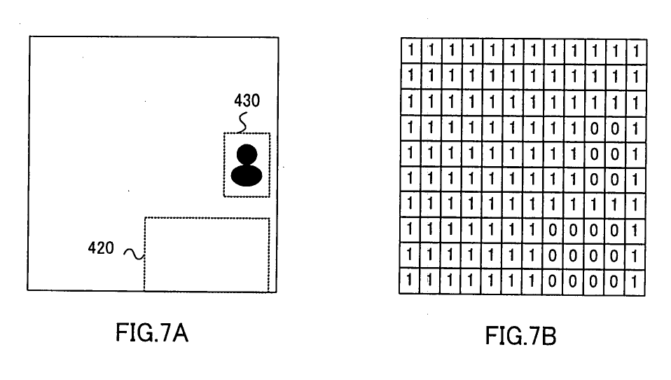

Furthermore, at a time (t+2), as shown in FIG. 7A, in addition to the area 420, when an area 430 becomes a non-background area, a non-background map as shown in FIG. 7B is created. In this way, as the time passes and the number of input images increases, the number of non-background areas having a large difference value from the background image increases, and therefore when this proportion increases, the coding mode is set to intra-coding and the background image is updated.

The non-background maps shown in FIG. 6B and FIG. 7B become background information with a predetermined header such as an image number added.

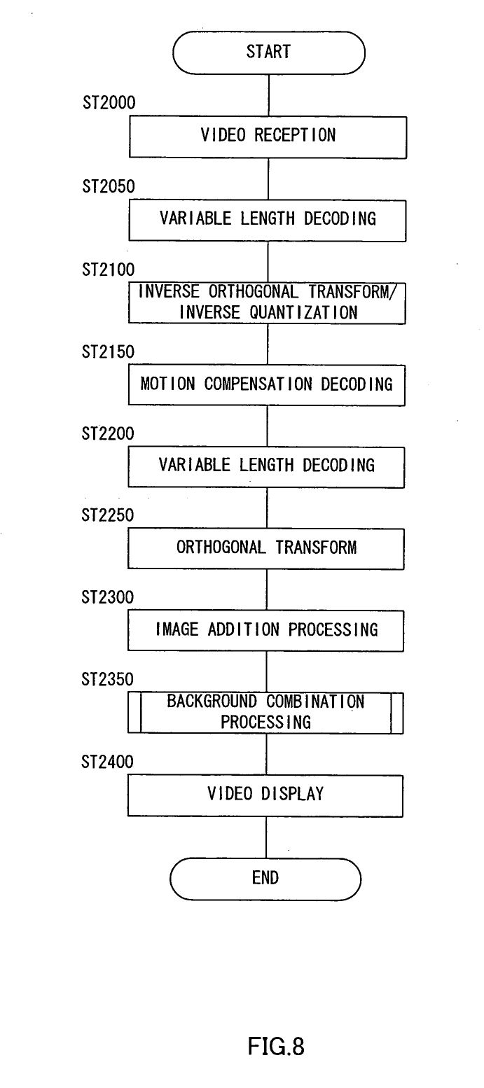

Next, the operation of the video reception apparatus 300 according to this embodiment will be explained using a flow chart shown in FIG. 8. The operation of the flow chart shown in FIG. 8 is stored in a storage device (such as ROM or flash memory) (not shown) of the video reception apparatus 300 as a control program and controlled by a CPU (not shown).

First, the video receiver 310 receives the video stream and coding mode information of the base layer from the network 200 and outputs the video stream and coding mode information to the base layer decoder 330 and the video receiver 320 receives the video stream and background information of the enhancement layer from the network 200 and outputs the video stream and background information to the enhancement layer decoder 340 (ST2000).

The video stream and coding mode information of the base layer output to the base layer decoder 330 are input to the variable length decoder 331 first. The variable length decoder 331 carries out variable length decoding on the video stream and coding mode information of the base layer (ST2050), outputs the orthogonal transform coefficients to the inverse quantizer 332, outputs the motion vector to the motion compensator 333 and outputs the coding mode information to the background combiner 350.

When the orthogonal transform coefficients is output to the inverse quantizer 332, the inverse quantizer 332 carries out inverse quantization processing and inverse orthogonal transform processing and decodes the error image (ST2100). The motion compensator 333 uses the preceding decoded image (reference image) based on the error image and motion vector and generates a decoded image of the base layer through the same operation as that of the base layer decoder 150 of the video transmission apparatus 100 (ST2150).

Thus, the base layer decoder 330 generates the decoded image of the base layer on one hand, and the enhancement layer decoder 340 generates the decoded image of the enhancement layer on the other.

More specifically, the video stream and background information of the enhancement layer output to the enhancement layer decoder 340 are input to the variable length decoder 341 first. Then, the variable length decoder 341 carries out variable length decoding on the video stream and background information of the enhancement layer (ST2200), outputs an orthogonal transform coefficients for each bit plane to the orthogonal transformer 342 and outputs the background information to the background combiner 350.

When the orthogonal transform coefficients is output to the orthogonal transformer 342, the orthogonal transformer 342 performs the inverse DCT transform (ST2250) and decodes the error image. When the coding mode is intra-coding, the entire area of this error image is the non-background area, but when the coding mode is non-intra-coding, part of the image becomes the non-background area and all pixel values of the background area are zeros. Then, the addition processor 343 carries out addition processing on the decoded image of the base layer and the error image output from the orthogonal transformer 342 and generates a decoded image (ST2300) The decoded image generated is output to the background combiner 350.

When either the base layer or enhancement layer is not correctly decoded in the addition processing in ST2300, it is also possible to skip the addition processing and output only the correctly decoded layer or output a blue-back image to the background combiner 350.

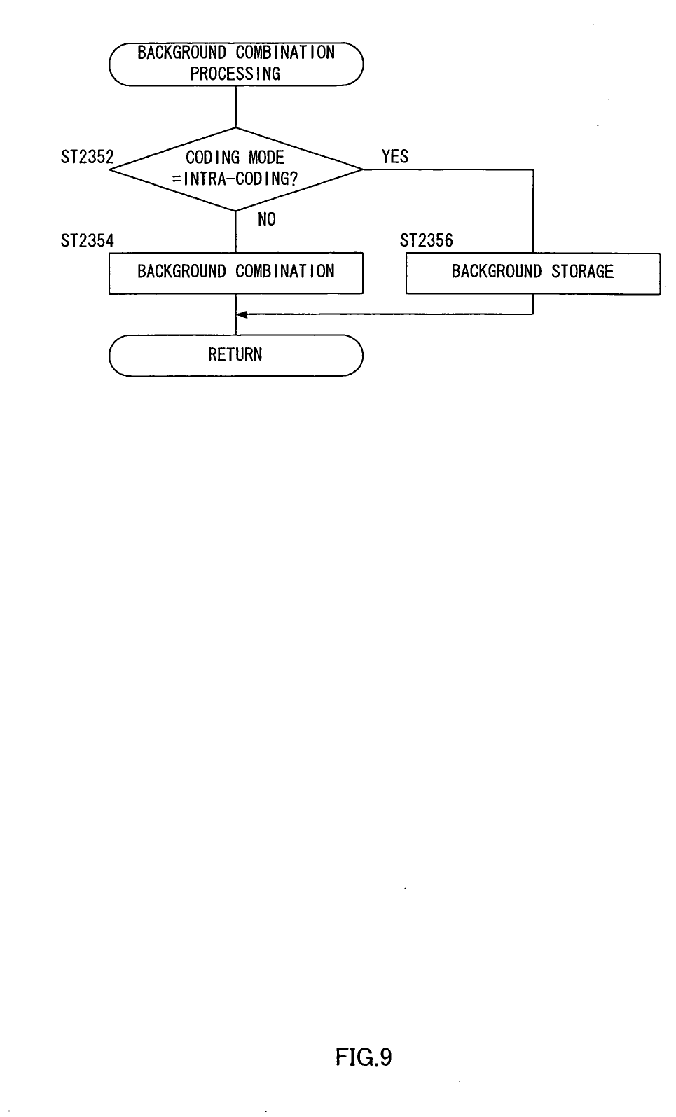

When the above described decoded image is obtained, the background combiner 350 performs background combination processing using the background area and decoded non-background area (ST2350) and generates a combined image. More specifically, processing as shown in a flow chart in FIG. 9 is carried out.

That is, the coding mode information output from the variable length decoder 331 is referenced first and it is decided whether the coding mode is intra-coding or not (ST2352).

When the result of this decision shows that the coding mode is intra-coding (ST2352 “YES”), the background image is stored (ST2356). That is, the background combiner 350 stores the decoded image as a new background image. As described above, when the coding mode is intra-coding, the entire image is the non-background area, and therefore the decoded image itself becomes a new background image.

On the other hand, when the result of the decision in ST2352 shows that the coding mode is non-intra-coding (ST2352 “No”), the background combiner 350 combines the decoded image output from the enhancement layer decoder 340 and the background image stored in the background combiner 350 (ST2354). At this time, the non-background map included in the background information is referenced and the decoded image is combined with the macro blocks expressed by “0” in the non-background map in the non-background area of the background image.

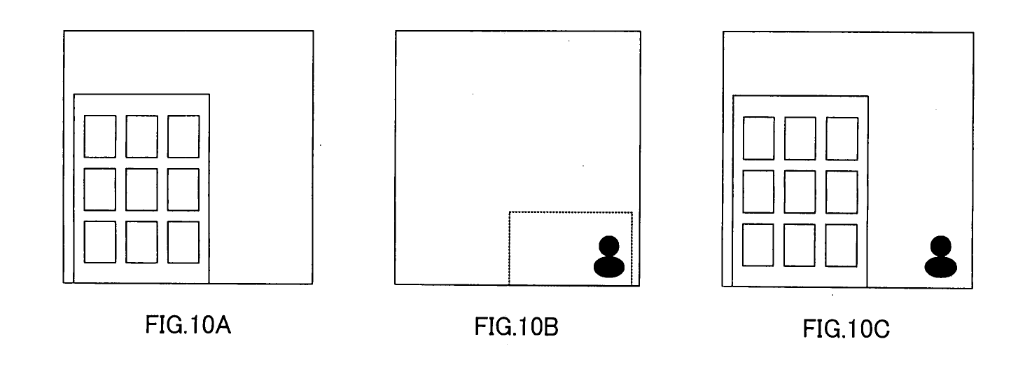

As a specific example, for example, FIG. 10A shows an image obtained by extracting a background area expressed by “1”s in the non-background map from a background image and FIG. 10B shows an image obtained by extracting a non-background area expressed by “0”s in the non-background map from a decoded image output from the enhancement layer decoder 340. The background combiner 350 extracts the figures shown in FIG. 10A and FIG. 10B with reference to the non-background map and combines these figures into a combined image shown in FIG. 10C.

The background combiner 350 combines the background area of the background image with the non-background area of the decoded image according to the non-background map, and can thereby decode the image while suppressing the processing load.

The background image is a decoded image obtained by always decoding an intra-coded image and is an image without using temporal prediction with respect to other images (frames) and not affected by preceding decoded images, and therefore even when the enhancement layer is lost on a network, drift noise never occurs.

Referring to FIG. 8 again, when a combined image is generated, the video display section 360 displays the combined image on a display device, etc., (ST2400).

Thus, according to this embodiment, the video transmission apparatus compares the input image with the background image which is an intra-decoded image and codes and transmits only the non-background area, and therefore it is possible to reduce the amount of data to be coded, reduce the amount of processing and improve coding efficiency.

Furthermore, according to this embodiment, the video reception apparatus combines the decoded image of only the non-background area and background image which is the decoded intra-coded image, and therefore even if the data of the enhancement layer is lost on the network, it is possible to combine the decoded image of the next enhancement layer with the background image which is an intra-coded image and prevent drift noise from occurring in the following decoded images.

This embodiment assumes the configuration that both the video transmission apparatus and video reception apparatus store only one background image, but it is also possible to store a plurality of background images and separate the background. In this case, it is possible to select a background image having the highest correlation with each input image out of the plurality of background images.

Furthermore, it is also possible to use different background images which differ from one macro block to another. In this case, it is possible to generate background information for each macro block group which uses the same background image and describe the number of the corresponding background image in the header of the background information. Thus, using a background image with a high correlation for each macro block can further improve the coding efficiency.

This embodiment carries out image coding processing, transmission processing, reception processing and image decoding processing synchronized with one another, but the present invention is not limited to this and these types of processing can also be performed asynchronously. That is, it is also possible to carry out image coding processing first and then carry out transmission processing, reception processing and decoding processing or carry out image coding processing, transmission processing and reception processing first and then carry out image decoding processing.

### Embodiment 2

A feature of Embodiment 2 of the present invention is to use a variance of a motion vector obtained when coding a base layer and to move, when this variance is equal to or lower than a certain value, the background image in the direction in which average motion vectors are accumulated and then separate the background to thereby reduce the proportion of the area which becomes a non-background area even when, for example, a surveillance camera, etc., rotates with in a predetermined range to take pictures, and improve the coding efficiency.

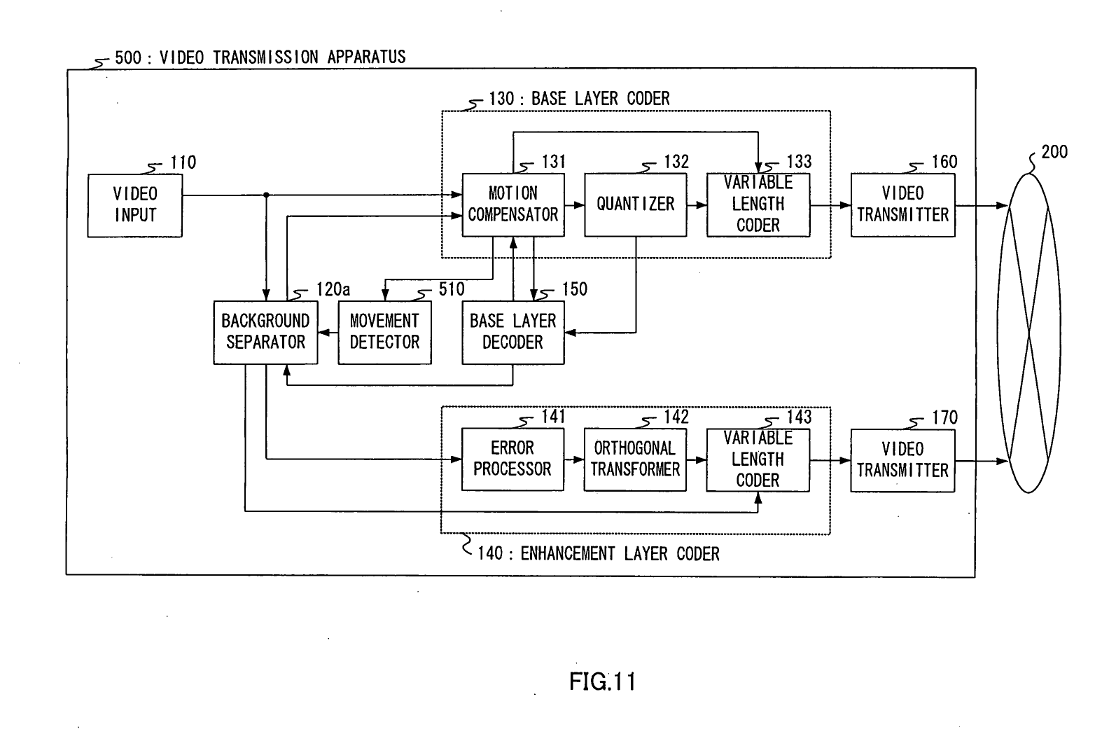

FIG. 11 is a block diagram showing the configuration of a video transmission apparatus according to Embodiment 2 of the present invention. In the video transmission apparatus shown in the same figure, the same components as those in the video transmission apparatus shown in FIG. 1 are assigned the same reference numerals and explanations thereof will be omitted. The video transmission apparatus 500 shown in FIG. 11 is provided with a video input 110, a background separator 120a, a base layer coder 130, an enhancement layer coder 140, a base layer decoder 150, a video transmitter 160, a video transmitter 170 and a movement detector 510.

The movement detector 510 calculates an average and a variance of motion vectors of the entire image obtained by the motion compensator 131 with respect to the X-axis and Y-axis respectively and decides, when the variance is equal to or lower than a predetermined threshold, that the entire background is moving to the particular direction. That is, if the motion vectors of the entire image tend to resemble, the movement detector 510 decides that the entire image is moving (e.g., a surveillance camera, etc., is panning), calculates an accumulated average of the motion vectors as a background motion vector and outputs the accumulated average to a background separator 120a. Furthermore, when the variance of the motion vector is equal to or higher than a predetermined threshold, the movement detector 510 outputs the information that the background is stationary to the background separator 120a.

The background separator 120a translates the entire input video input from the video input 110 in the direction of the background motion vector, then compares differences between the input image and the background image and determines the background area and non-background area for each macro block. Furthermore, the background separator 120a replaces pixel values of the background area with zeros in the input image and reference image generated by the base layer decoder 150 and outputs the values to the error processor 141.

Furthermore, the background separator 120a generates information indicating whether each macro block is a background area or not and background information including information on the background motion vector and outputs the information to the variable length coder 143. Furthermore, the background separator 120a outputs the coding mode information to the motion compensator 131 in the base layer coder 130 and stores, when the coding mode is intra-coding, the input image as a background image.

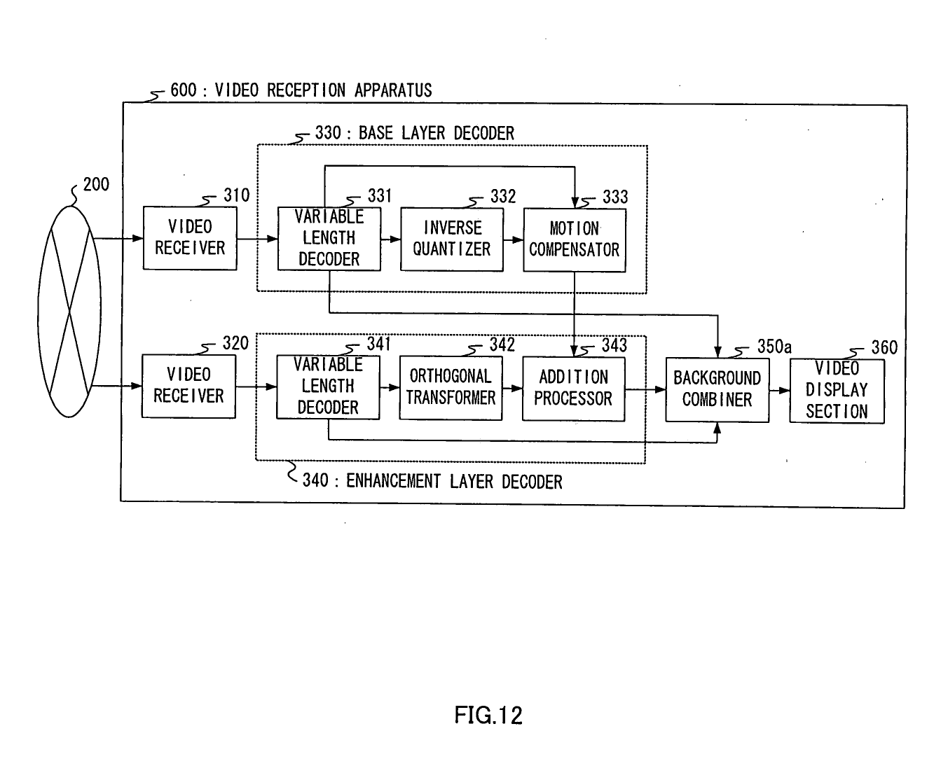

FIG. 12 is a block diagram showing the configuration of a video reception apparatus according to Embodiment 2. In the video reception apparatus shown in the same figure, the same components as those in the video reception apparatus shown in FIG. 2 are assigned the same reference numerals and explanations thereof will be omitted. The video reception apparatus 600 shown in FIG. 12 is provided with a video receiver 310, a video receiver 320, a base layer decoder 330, an enhancement layer decoder 340, a background combiner 350a and a video display section 360.

The background combiner 350a moves a prestored background image in the direction of a background motion vector included in the background information output from the variable length decoder 341. Furthermore, the background combiner 350a combines the background area of the background image moved according to the non-background map included in the background information and the decoded image obtained by the addition processor 343. That is, the background combiner 350a combines the background area of the moved background image and the non-background area of the decoded image and outputs the combined image to the video display section 360 on one hand, and when the coding mode is intra-coding, the background combiner 350a stores the decoded image as a new background image.

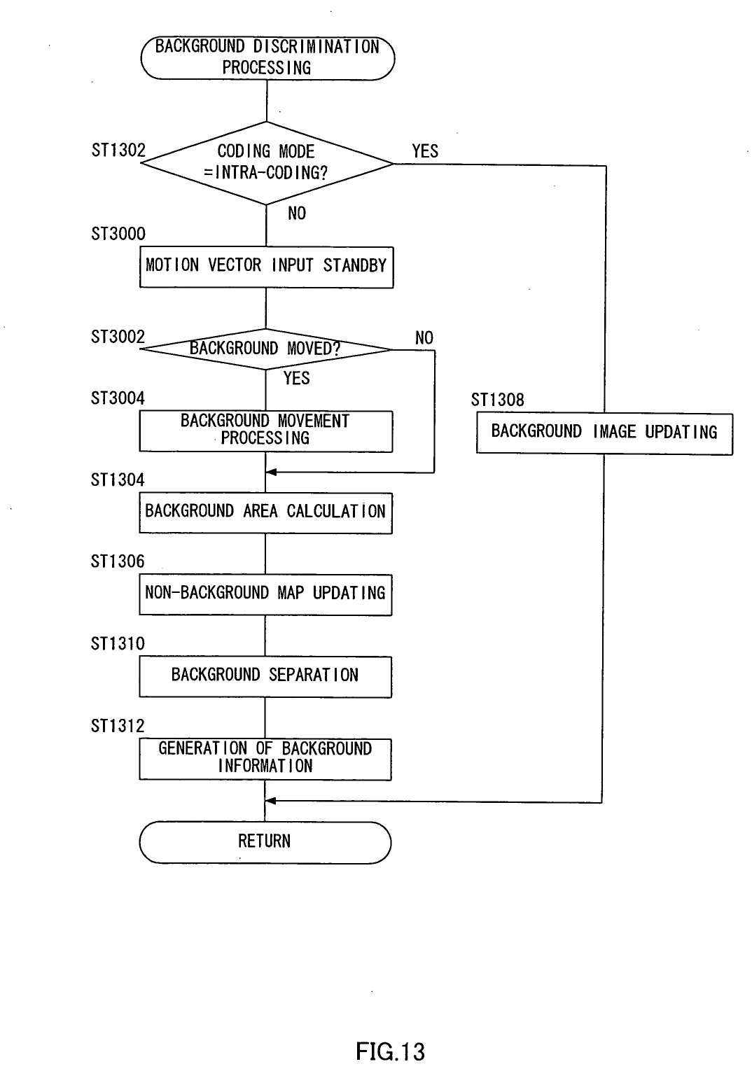

Next, the operation of the video transmission apparatus 500 in the above described configuration will be explained, but since the operation of the entire apparatus is the same as that in FIG. 3, the background discrimination processing in ST1300 in FIG. 3 will be explained with a specific example and using a flow chart in FIG. 13. The same steps shown in the same figure as those in the flow chart shown in FIG. 4 are assigned the same reference numerals and explanations thereof will be omitted.

As a result of the decision in ST1302, when it is decided that the coding mode is not intra-coding, that is, the coding mode is non-intra-coding, the movement detector 510 waits for the input of the motion vector of the entire image from the motion compensator 131 (ST3000). When the motion vector is not input despite the wait for a predetermined time, the movement detector 510 outputs information indicating that the background is stationary to the background separator 120a.

Then, when motion vectors of the entire image are input to the movement detector 510, a variance and average of these motion vectors are calculated on the X-axis and Y-axis respectively and it is decided whether the variance is equal to or lower than a predetermined threshold or not, and it is thereby decided whether the entire background is moving or not (ST3002). That is, if the variance of the motion vector is equal to or lower than a predetermined threshold, it is decided that the entire background is moving and if the variance of the motion vector exceeds the predetermined threshold, it is decided that the entire background is stationary.

When it is decided that the entire background is moving, the movement detector 510 calculates the background motion vector as follows and outputs the background motion vector to the background separator 120a. That is, the background motion vector (MVX, MVY) is calculated through accumulation of the X-axis component AVR_X and Y-axis component AVR_Y of an average of the motion vector with respect to a time T as shown in (Expression 1) below:
MVX(T+1)=MVX(T)+AVR_{—}X(T)
MVY(T+1)=MVY(T)+AVR_{—}Y(T) (Expression 1)

On the other hand, when it is decided that the entire background is stationary, the movement detector 510 outputs information indicating that the background is stationary to the background separator 120a.

Then, the background separator 120a carries out movement processing on the background image using the background motion vector (ST3004). That is, the stored background image, namely the preceding intra-coded image is moved according to the background motion vector.

More preferably, the input image is compared with the moved background image and the vector at the position with the highest correlation of both images, that is, a motion vector of the corrected background is calculated pixel by pixel and the background image is moved in the direction of the motion vector of the corrected background. It is also possible to avoid calculations of the motion vector of the corrected background to reduce the processing load.

Hereinafter, the background area will be separated from the non-background area as in the case of Embodiment 1, but in this embodiment, the background area is separated from the non-background area using the moved background image. Furthermore, the background area in this embodiment includes information on the background motion vector.

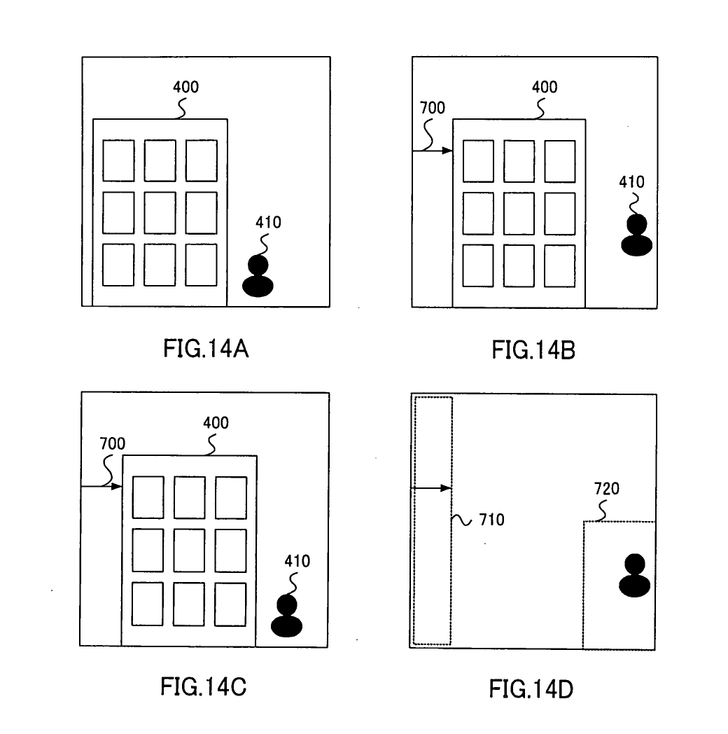

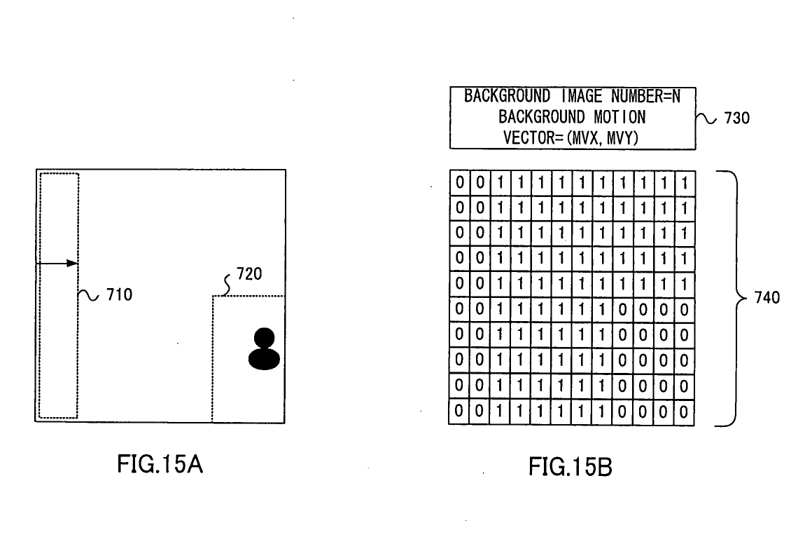

A specific example of the background discrimination processing is shown below using FIG. 14 and FIG. 15.

Suppose FIG. 14A shows a background image and FIG. 14B shows an input image. In these figures, an object 400 is stationary, while an object 410 is moving and only the entire background is moving by a background motion vector 700. In such a case, the background separator 120a moves the background image by the background motion vector 700 and an image as shown in FIG. 14C is obtained. Then, the background separator 120a carries out difference processing between the input image (FIG. 14B) and the moved background image (FIG. 14C) and as a result, the area including the object 400 becomes a background area and only the area 710 and area 720 shown in FIG. 14D become the non-background areas.

Here, if the movement detector 510 does not detect the movement of the entire background, difference processing is carried out using FIG. 14A as the background image, and therefore the entire image becomes the non-background area although the object 400 is stationary. However, this embodiment detects the movement of the entire background and carries out difference processing after moving the background image, and therefore it is possible to reduce the proportion of the non-background area and improve the coding efficiency.

Then, pixel values of areas other than the area 710 and area 720 shown in FIG. 15A are replaced by zeros and the background information shown in FIG. 15B is generated. The background information shown in FIG. 15B is made up of a header 730 having information on the background motion vector and a non-background map 740 in which the above described area 710 and area 720 are updated to “0”s indicating non-background areas.

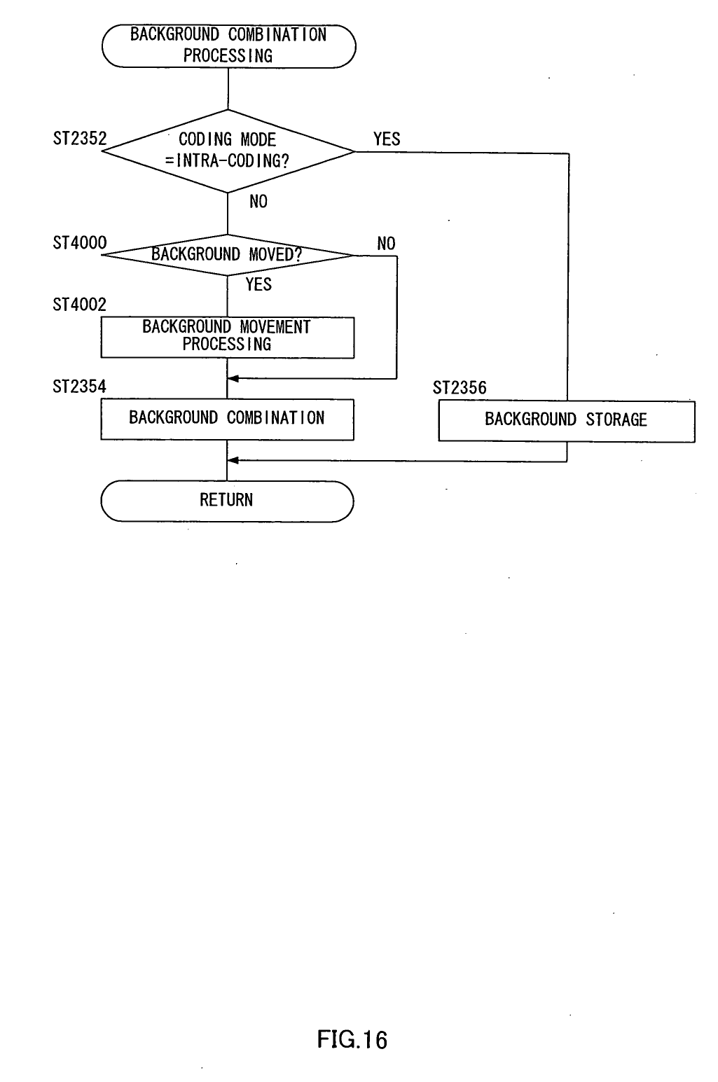

Next, the operation of the video reception apparatus 600 according to this embodiment will be explained, but the operation of the entire apparatus is the same as that in FIG. 8, and therefore the background combination processing in ST2350 in FIG. 8 will be explained with a specific example and using a flow chart in FIG. 16. In the flow chart shown in the same figure, the same steps as those shown in FIG. 9 are assigned the same reference numerals and explanations thereof will be omitted.

As a result of the decision in ST2352, if it is decided that the coding mode is non-intra-coding (ST2352 “YES”), the background combiner 350a refers to the background motion vector out of the background information output from the variable length decoder 341 and decides whether the entire background is moving or not (ST4000). That is, the background combiner 350a decides whether the background motion vector is “0” or not and if the background motion vector is “0”, it is decided that the entire background is stationary and if the background motion vector is not “0”, it is decided that the entire background is moving.

Then, when it is decided that the entire background is moving, the background combiner 350a moves a prestored background image in the direction of the background motion vector (ST4002). Hereinafter, the background area and non-background area are combined as in the case of Embodiment 1, but the moved background image is used as the background image.

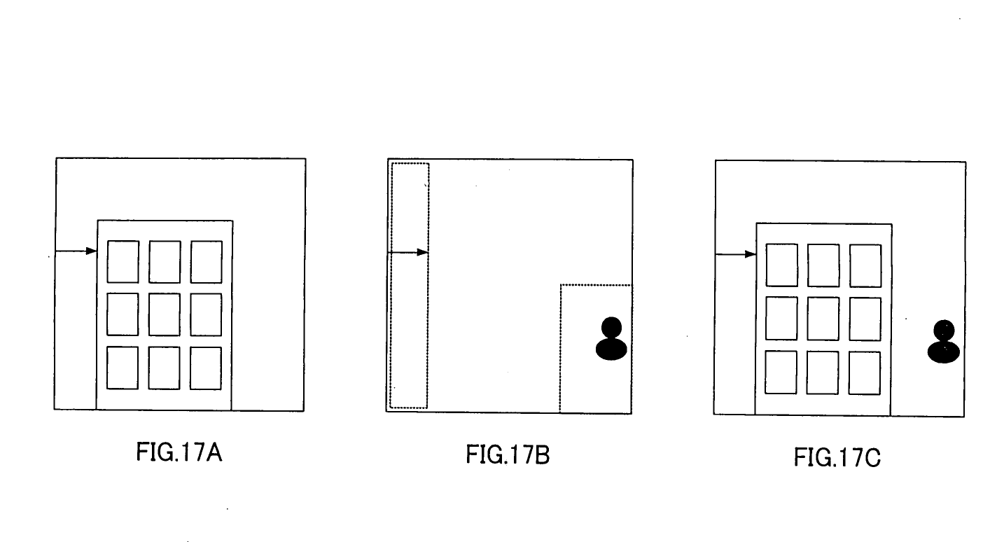

When a specific example is taken, for example, FIG. 17A shows an image obtained by extracting the background area expressed by “1”s in the non-background map after moving the background image in the direction of the background motion vector and FIG. 17B shows an image obtained by extracting the non-background area expressed by “0”s in the non-background map from the decoded image output from the enhancement layer decoder 340. The background combiner 350a refers to the background motion vector and non-background map, extracts the images shown in FIG. 17A and FIG. 17B and combines the images to generate a combined image as shown in FIG. 17C.

Thus, according to this embodiment, when the entire background is moving, the video transmission apparatus obtains a background motion vector, moves the background image by the background motion vector and then carries out difference processing between the background image and the input image, and therefore it is possible to accurately extract the background area which is actually stationary, codes and sends only the non-background area image, and improve the coding efficiency even when the video transmission apparatus is, for example, panning.

### Embodiment 3

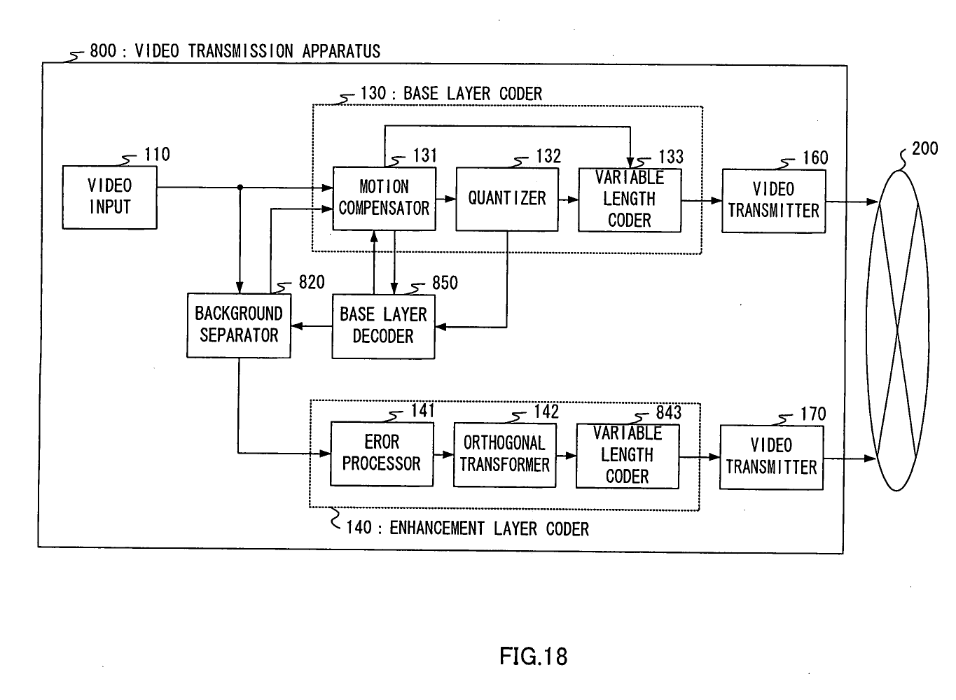

FIG. 18 is a block diagram showing the configuration of a video transmission apparatus according to Embodiment 3 of the present invention.

The video transmission apparatus 800 shown in FIG. 18 is provided with a video input 110, a background separator 820, a base layer coder 130, an enhancement layer coder 140, a base layer decoder 850, a video transmitter 160, and a video transmitter 170 and the functional blocks having the same operations as those in Embodiment 1 are assigned the same reference numerals as those in FIG. 1 and explanations of the operations will be omitted.

The background separator 820 compares and finds differences between a past background image which is a base layer decoded image coded in intra-coding and a base layer decoded image of the current frame and determines a background area which is an area with no variation in pixel values and a non-background area which is an area other than the background area for each macro block made up of 16×16 pixels. Therefore, the background area is the area having the same pixel values of base layer decoded image as those of the background image intra-coded in the past of the base layer decoded image and the non-background area is the area having pixel values different from those of the background image intra-coded in the past.

Furthermore, the background separator 820 replaces pixel values of the background area of the input image and the decoded image of the base layer (hereinafter referred to as “reference image”) generated by the base layer decoder 150 with zeros and outputs the values to the error processor 141 in the enhancement layer coder 140.

Furthermore, the background separator 820 decides the coding mode as to whether or not to carry out intra-coding and outputs the coding mode information to the motion compensator 131 in the base layer coder 130 and stores, when the coding mode is intra-coding, the base layer decoded image as the background image.

A variable length coder 843 carries out variable length coding processing on an orthogonal transform coefficients using a variable length coding table for each bit plane and outputs a video stream of the enhancement layer obtained to the video transmitter 170.

The base layer decoder 850 carries out inverse quantization and inverse orthogonal transform processing on the orthogonal transform coefficients output from a quantizer 132 and reconstructs the error image. Furthermore, the base layer decoder 150 carries out addition processing on the reference image and error image used at a motion compensator 131 using the preceding decoded image and motion vector output from the motion compensator 131 to thereby generate a new decoded image (reference image) and outputs the decoded image to the background separator 820.

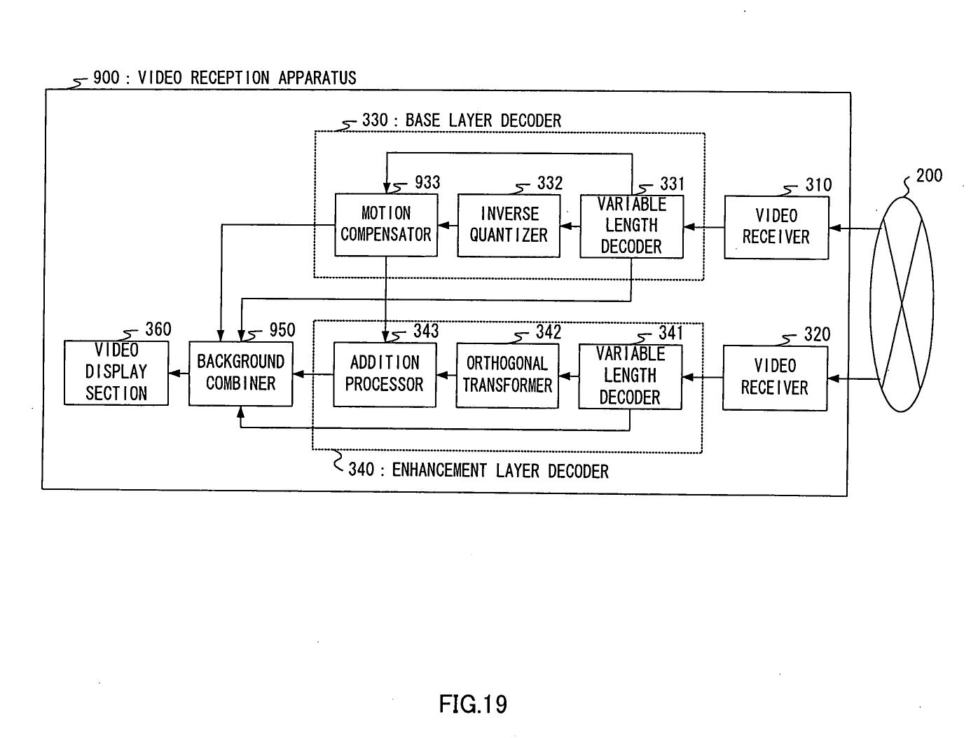

FIG. 19 is a block diagram showing the configuration of a video reception apparatus according to Embodiment 3.

The video reception apparatus 900 shown in FIG. 19 is provided with a video receiver 310, a video receiver 320, a base layer decoder 330, an enhancement layer decoder 340, a background combiner 950 and a video display section 360, and the blocks assigned the same reference numerals as those in FIG. 2 have the same operations as those in Embodiment 1, and therefore explanations of the operations will be omitted.

A motion compensator 933 generates a new decoded image using an error image output from an inverse quantizer 332, a motion vector output from a variable length decoder 331 and a preceding decoded image and outputs the base layer decoded image to an addition processor 343 and background combiner 950.

The background combiner 950 performs background discrimination using the base layer decoded image obtained from the motion compensator 933 and a background image which is a prestored base layer decoded image and performs background combination on the decoded image and background image obtained by the addition processor 343. That is, the background combiner 950 compares and finds differences between the background image which is the preceding base layer decoded image and the base layer decoded image of the current frame and determines a background area which is the area with no variation in pixel values and a non-background area which is an area other than the background area for each macro block made up of 16×16 pixels. The background combiner 950 combines the background area of the background image and the non-background area of the decoded image according to the determined background information and outputs the combined image to the video display section 360 on one hand, and stores, when the coding mode is intra-coding, the current base layer decoded image as a new background image.

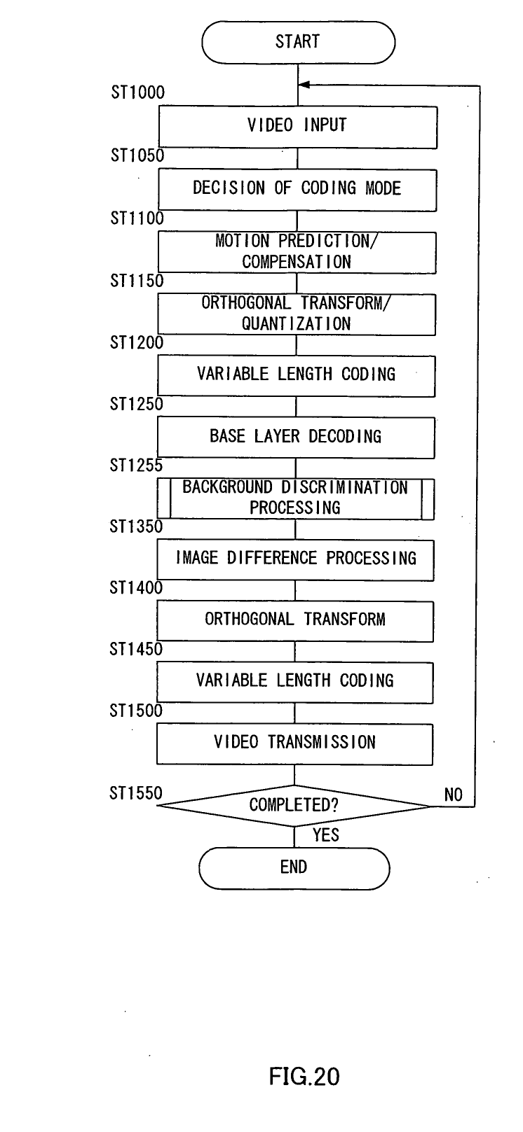

Next, the operation of the video transmission apparatus 800 having the above described configuration will be explained using the flow chart shown in FIG. 20.

FIG. 20 is a flow chart showing the operation of the video transmission apparatus 800 according to Embodiment 3.

The operation of the flow chart shown in FIG. 20 is stored as a control program in a storage device (not shown) (e.g., ROM or flash memory, etc.) of the video transmission apparatus 800 shown in FIG. 18 and controlled by a CPU (not shown). Furthermore, processing steps in FIG. 20 assigned the same step numbers as those in FIG. 3 show the same operations as those in Embodiment 1 and explanations of the operations will be omitted.

As shown in FIG. 18, when an image is input to the video input 110, the image signal is output to the base layer coder 130 and at the same time output to the background separator 820.

The background separator 820 carries out background discrimination processing (ST800). More specifically, the background separator 820 separates the background area from the non-background area in macro block units using the base layer coded and local-decoded base layer decoded image to generate background information indicating whether each macro block is a background area or not. Furthermore, the background separator 120 replaces pixel values of the background areas of the input image and reference image by zeros and outputs the values to the error processor 141. The background discrimination processing of the background separator 120 will be explained in detail later.

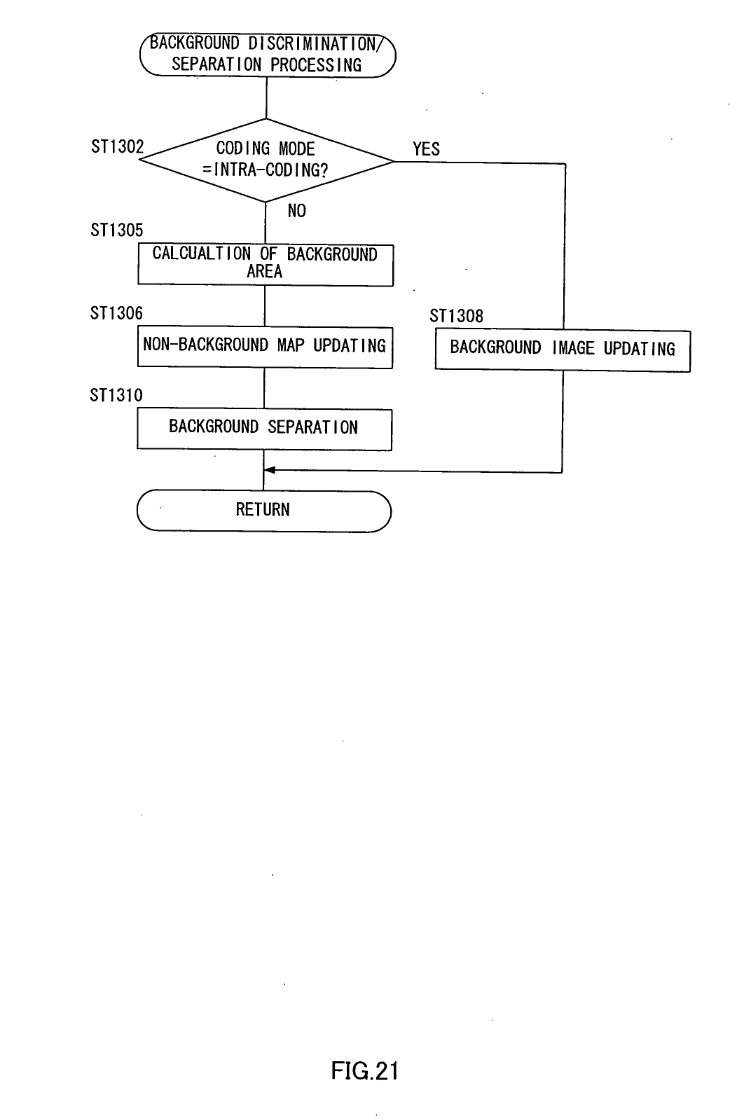

Next, the background discrimination processing of the above described video transmission apparatus 800 will be explained with a specific example and using a flow chart in FIG. 21.

FIG. 21 is a flow chart showing the background discrimination processing in the background separator 820 according to Embodiment 3.

Processing steps in FIG. 21 assigned the same step numbers as those in FIG. 4 show the same processing as that in Embodiment 1 and explanations of the processing will be omitted.

First, as a result of a decision of the coding mode in ST1050 in FIG. 20, the background separator 820 decides whether the coding mode is intra-coding or not (ST1302).

When this decision result shows that the coding mode is intra-coding (ST1302 “YES”), the background image is updated (ST1308). That is, the background separator 820 stores the base layer decoded image as a new background image. As described above, after the preceding background image is updated, that is, intra-coding is performed, a predetermined number of images are input or when the proportion of the non-background area is greater, the coding mode is intra-coding, and therefore it is possible to minimize the following non-background areas by updating the background image at this time. As a result, it is possible to increase background areas of error images to be subsequently coded whose pixel values become zeros and reduce the areas to be actually coded and improve the coding efficiency.

Furthermore, when it is decided that the coding mode is intra-coding, if the background separator 820 creates a non-background map in which the background area is shown with “1”s and the non-background area is shown with “0”s for each macro block, all macro blocks are initialized by “1”s, that is, the background area.

On the other hand, if the result of the decision in ST1302 shows that the coding mode is not intra-coding, that is, non-intra-coding such as inter-coding in which coding is performed using a correlation with other frames (ST1302 “No”), the background separator 820 carries out difference processing between the base layer decoded image of the current frame and the background image which is the preceding base layer decoded image for each macro block and regards macro blocks in which the sum of absolute values of difference values of pixels in the macro blocks is equal to or lower than a predetermined threshold as background areas and regards other macro blocks as non-background areas (ST1305). The preceding background image refers to a base layer decoded image stored in the background separator 820 when the preceding coding mode is intra-coding.

Then, as in the case of Embodiment 1, the non-background map updating processing (ST1306) shown in FIG. 4 and background separation processing (ST1310) are carried out, but unlike Embodiment 1, Embodiment 3 carries out no background information generation processing (ST1312) shown in FIG. 4.

Thus, this Embodiment 3 does not generate background information which is generated in Embodiment 1 or send the background information to the receiving side. This is because the video reception apparatus 900 which will be explained later carries out background discrimination using the base layer decoded image as in the case of the background separator 820 in the video transmission apparatus 800, and can thereby uniquely identify the background area without transmitting/receiving background information. This makes it possible to reduce overhead of the background information and reduce the amount of data transmitted/received and improve the coding efficiency consequently.

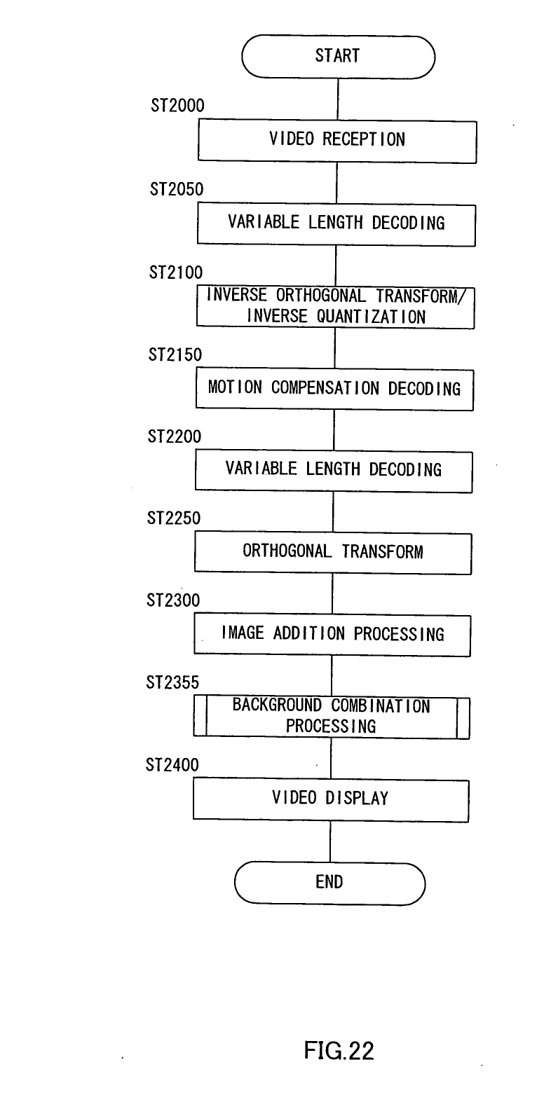

Next, the operation of the video reception apparatus 900 according to this Embodiment 3 will be explained using a flow chart shown in FIG. 22.

FIG. 22 is a flow chart showing the operation of the video reception apparatus 900 according to Embodiment 3.

The operation of the flow chart shown in FIG. 22 is stored as a control program in a storage device (not shown) (e.g., ROM or flash memory) of the video reception apparatus 900 and controlled by a CPU (not shown). Processing steps in FIG. 22 assigned the same step numbers as those in FIG. 8 show the same processing as that in Embodiment 1 and explanations of the processing steps will be omitted.

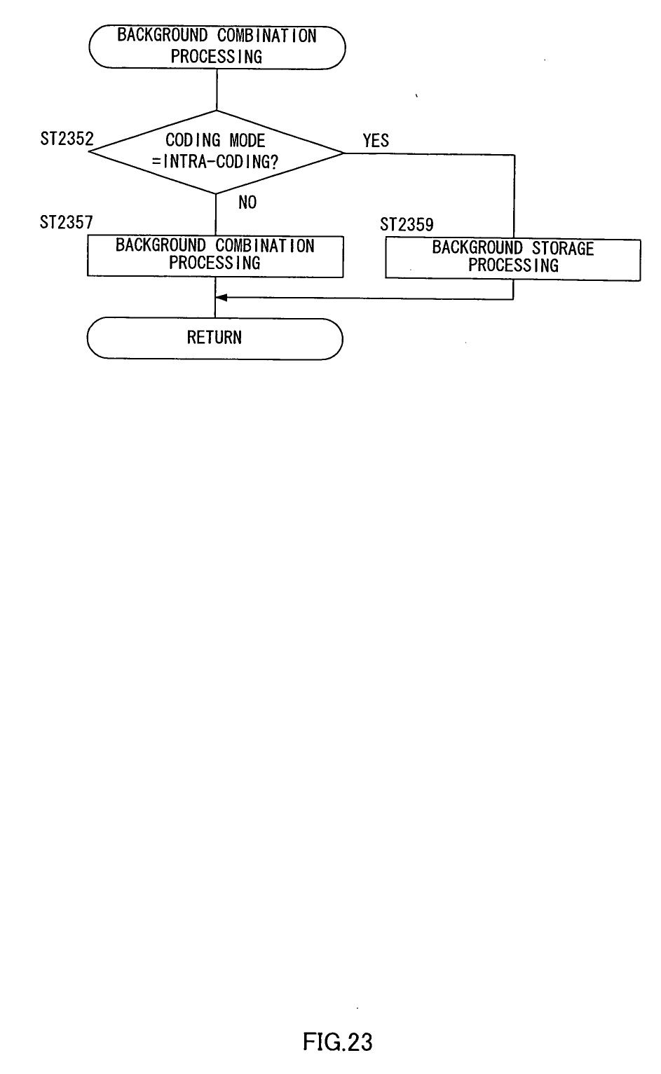

When the video reception apparatus 900 according to Embodiment 3 receives an image signal sent from the video transmission apparatus 800 and compressed/coded and obtains a decoded image, the background combiner 950 carries out background combination processing (ST2355) using the background area of the background image and decoded non-background area without using the background information unlike the case with Embodiment 1 and generates a combined image. More specifically, the processing as shown in a flow chart in FIG. 23 is carried out.

FIG. 23 is a flow chart showing the background combination processing of the background combiner 950 according to Embodiment 3.

That is, the background combiner 950 decides whether the coding mode is intra-coding or not with reference to the coding mode information output from the variable length decoder 331 (ST2352).

When the result of this decision shows that the coding mode is intra-coding (ST2352 “YES”), the background image is stored (ST2359). That is, the background combiner 950 stores the base layer decoded image as a new background image. As described above, when the coding mode is intra-coding, the entire image is a non-background area, and therefore the base layer decoded image itself becomes a new background image.

On the other hand, when the result of the decision in ST2352 shows that the coding mode is not intra-coding, that is, non-intra-coding (ST2352 “No”), the background combiner 950 carries out background discrimination and as a result of the decision, combines the decoded image output from the enhancement layer decoder 340 and the background image stored in the background combiner 350 (ST2357).

More specifically, the background combiner 950 carries out difference processing between the current base layer decoded image obtained from the motion compensator 933 and the background image which is the preceding base layer decoded image decoded from the received video stream and stored for each macro block and decides the macro block whose sum of absolute values of difference values of pixels in the macro block is equal to or lower than a threshold as a background area and the other macro block as a non-background area.

Next, the background combiner 950 combines the background image of the background area and the decoded image of the non-background area based on the decision result.

Thus, unlike Embodiment 1, in this Embodiment 3, even the video reception apparatus 900 decides the background area and non-background area through the difference processing between the base layer decoded image and background image as in the case of the video transmission apparatus 800 without using the background information, combines the background area of the background image and the non-background area of the decoded image, and can thereby decode images while suppressing the amount of data received.

Therefore, according to this Embodiment 3, the video transmission apparatus 800 compares the input image and the background image which is an intra-coded image, codes and sends only the non-background area, and can thereby reduce the amount of data to be coded, reduce the amount of processing and improve the coding efficiency.

Furthermore, according to this Embodiment 3, both the video transmission apparatus 800 and video reception apparatus 900 carry out a background decision using the same base layer decoded image, which eliminates the need for the video transmission apparatus 800 to code and transmit/receive the background information and allows the video reception apparatus 900 to uniquely determine the background area without using the background information, and therefore it is possible to reduce the amount of code of background information and improve the coding efficiency in this respect, too.

Here, as in the case of Embodiment 2, this Embodiment 3 does not assume any case where the entire background is moving, it is of course possible, as in the case of Embodiment 2 above, to use a variance of the motion vector obtained when the video transmission apparatus codes a base layer and move, when this variance is equal to or lower than a predetermined value, the background image in the direction in which average motion vectors are accumulated, carry out difference processing from the base layer decoded image and then perform background separation. As with Embodiment 2 above, by so doing, it is possible to accurately extract an actually stationary background area, code and send only the non-background area, and even when, for example, a video transmission apparatus is panning, it is possible to improve the coding efficiency, and even when, for example, a surveillance camera, etc., is taking pictures while moving around within a predetermined range, it is possible to reduce the proportion of the area which becomes a non-background area and improve the coding efficiency in the sense that background information is not transmitted/received.

As described above, the video communication apparatus according to an embodiment of the present invention separates an input image into a background area and a non-background area, codes the separated non-background area, transmits a video stream of the non-background area obtained through coding, that is, separates an input image into a background area and a non-background area and transmits the coded non-background area, and can thereby reduce the amount of data to be coded and improve the coding efficiency while suppressing the processing load. Furthermore, the video stream receiving side combines a prestored background image with an image of the non-background area, and can thereby obtain a correct decoded image and prevent drift noise without being affected by variations in the amount of data received.

Especially by coding the entire area of an input image in a base layer, coding the non-background area included in the input image in an enhancement layer, sending a video stream of the coded base layer and a video stream of the coded enhancement layer, thereby coding the entire input image in the base layer, coding the non-background area in the enhancement layer and sending the respective areas, it is possible, for example, when layered coding such as MPEG-4 FGS is performed, to reduce the amount of data to be coded, improve the coding efficiency while suppressing the processing load and prevent drift noise in the enhancement layer susceptible to drift noise.

Furthermore, by regarding an area where a difference value calculated by carrying out difference processing between the background image stored as a preceding input image and an input image this time is equal to or lower than a predetermined threshold as a background area and the area other than the background area as a non-background area, that is, regarding the area where the difference value between the background image and input image is equal to or lower than a predetermined threshold as a background area, it is possible to accurately separate the background area from the non-background area.

Furthermore, by regarding an area where a difference value calculated by carrying out difference processing between the background image stored as a coded and decoded preceding input image and an input image this time is equal to or lower than a predetermined threshold as a background area and the area other than the background area as a non-background area, that is, regarding the area where the difference value between the background image and input image is equal to or lower than a predetermined threshold as a background area, it is possible to accurately separate the background area from the non-background area.

Furthermore, by regarding an area where a difference value calculated by carrying out difference processing between the background image stored as the entire area of a preceding input image coded and decoded in a base layer and a base layer decoded image obtained through coding and decoding the entire area of the input image this time in the base layer is equal to or lower than a predetermined threshold as a background area and the area other than the background area as a non-background area, that is, regarding the area where the difference value between the background image and base layer decoded image is equal to or lower than a predetermined threshold as a background area, it is possible to accurately separate the background area from the non-background area.

Furthermore, by separating an input image into a background area and a non-background area using a background image having the highest correlation with the input image this time out of a plurality of background images stored as the coded and decoded input image, that is, separating the background area from the non-background area using the background image having the highest correlation with the input image out of a plurality of background images, it is possible to reduce the non-background area in the input image, further reduce the amount of data to be coded and improve the coding efficiency while suppressing the processing load.

Furthermore, by separating an input image into a background area and a non-background area using a background image having the highest correlation with a base layer decoded image obtained through coding and decoding the entire area of the input image this time out of a plurality of background images stored as the entire area of the input image coded and decoded in a base layer, that is, separating the background area from the non-background area using the background image having the highest correlation with the base layer decoded image obtained through coding and decoding the entire area of the input image this time in a base layer, it is possible to reduce the non-background area in the input image, further reduce the amount of data to be coded and improve the coding efficiency while suppressing the processing load.

Furthermore, by separating an input image into a background area and a non-background area in units of a macro block made up of a predetermined number of pixels, that is, separating a background area from a non-background area using a macro block of the input image as a unit, it is possible to efficiently separate the background area from the non-background area.

Furthermore, when the proportion of the non-background area in the input image is equal to or greater than a predetermined threshold, by generating coding mode information that intra-coding without using a correlation with other frames of the input image should be carried out, intra-coding the entire area of the input image according to the coding mode information generated, storing the input image as the background image and sending the intra-coded input image and the coding mode information, it is possible, when the non-background area is large, to store the input image as the background image, intra-code the entire area of the input image, thereby reduce the non-background area in the following input images and further improve the coding efficiency.

Furthermore, when the proportion of the non-background area in the input image is equal to or greater than a predetermined threshold, by generating coding mode information that intra-coding without using a correlation with other frames of the input image should be carried out, intra-coding as well as intra-decoding the entire area of the input image according to the coding mode information generated, storing the intra-decoded input image as the background image and sending the intra-coded input image and the coding mode information, it is possible, when the non-background area is large, to store images obtained through coding and decoding the input image as the background image, intra-code the entire area of the input image, thereby reduce the non-background area in the following input images and further improve the coding efficiency.

Furthermore, when the proportion of the non-background area in the input image is equal to or greater than a predetermined threshold, by generating coding mode information that intra-coding without using a correlation with other frames of the input image should be carried out, intra-coding the entire area of the input image according to the coding mode information generated in the base layer, storing the intra-decoded input image as the background image and sending the intra-coded input image and coding mode information in the base layer, it is possible, when the non-background area is large, to intra-code as well as intra-decode the entire area of the input image in the base layer, store images obtained by intra-decoding the input image as the background image and intra-code the entire area of the input image in the base layer, and thereby reduce the non-background area in the following input images and further improve the coding efficiency.

Furthermore, when the proportion of the non-background area in the input image is equal to or greater than a predetermined threshold, by generating coding mode information that intra-coding without using a correlation with other frames of the input image should be carried out, intra-coding the entire area of the input image according to the coding mode information, storing the decoded image generated by intra-decoding the intra-coded input image as the background image and sending the intra-coded input image and coding mode information, it is possible, when the non-background area is large, to intra-code the input image and store the intra-decoded decoded image as the background image, and thereby reduce the non-background area in the following input images and further improve the coding efficiency.

Furthermore, when the proportion of the non-background area in the input image is equal to or greater than a predetermined threshold, by generating coding mode information that intra-coding without using a correlation with other frames of the input image should be carried out, intra-coding the entire area of the input image according to the coding mode information in the base layer, storing the decoded image generated by intra-decoding the intra-coded input image as the background image and sending the intra-coded input image and the coding mode information in the base layer, it is possible, when the non-background area is large, to intra-code the entire area of the input image in the base layer and store the intra-decoded decoded image as the background image, and thereby reduce the non-background area in the following input images and further improve the coding efficiency.

Furthermore, by generating background information indicating the positions of the background area and non-background area in the input image and sending the background information together with the video stream, that is, sending the background information together with the video stream, it is possible for the receiving side of the video stream to accurately combine the prestored background image and the image of the non-background area.

Furthermore, by detecting movement of the entire image of the input image, moving the prestored background image by the amount of movement of the entire image and carrying out difference processing from the input image, that is, detecting movement of the entire image and carrying out difference processing after moving the background image by the amount of movement of the entire image, it is possible to accurately extract the background area which is actually stationary, code and send only the non-background area and improve the coding efficiency even when the video transmission apparatus is panning, for example.

Furthermore, when movement of the entire image of an input image is detected, by deciding that the entire image is moving and calculating the motion vector when a variance of the motion vector of the entire image calculated during coding is equal to or lower than a predetermined threshold, that is, deciding that the entire image is moving when the variance of the motion vector of the entire image is small, it is possible to accurately detect movement of the entire image.

Furthermore, when movement of the entire image of an input image is detected, by calculating a background motion vector which is a value obtained by accumulating motion vector averages and carrying out difference processing from the input image after moving a prestored background image according to the background motion vector, that is, calculating a background motion vector and moving the background image according to the background motion vector, it is possible to accurately move the background image by the amount of movement of the entire image.

Furthermore, the video communication apparatus according to an embodiment of the present invention receives a video stream of a non-background area, decodes the received video stream and combines the image of the non-background area obtained through decoding from the received video stream and a prestored background image, that is, decodes the video stream of the received non-background area and combines with the prestored background image, and can thereby obtain a correct decoded image and prevent drift noise without being affected by variations in the amount of data received.

Furthermore, the video communication apparatus according to an embodiment of the present invention receives a video stream of a non-background area, decodes the received video stream, discriminates the background area from the non-background area based on the base layer decoded image obtained through decoding from the received video stream and the background image which has been decoded from the received video stream and prestored, and combines the image of the non-background area obtained through decoding and the background area of the prestored background image based on the decision result, that is, discriminates the background area from the non-background area based on the background image and the base layer decoded image even if the coding side does not send the background information indicating the positions of the background area and non-background area, decodes the video stream of the received non-background area and combines with the background image, and can thereby obtain a correct decoded image, reduce the amount of data corresponding to the amount of the background information which is not transmitted/received and further improve the coding efficiency and prevent drift noise.

Especially by receiving the video stream of the base layer related to the entire area of the image and the video stream of the enhancement layer related to only the non-background area of the image, decoding the video stream of the base layer and decoding the video stream of the enhancement layer, that is, decoding the video stream of the base layer related to the entire image and decoding the video stream of the enhancement layer related to only the non-background area, it is possible to prevent drift noise in the enhancement layer susceptible to drift noise when, for example, layered coding such as MPEG-4 FGS is performed.

Furthermore, by receiving coding mode information indicating that the video stream is intra-coded, storing the decoded image of the intra-coded video stream as a background image, that is, regarding the decoded image of the intra-coded video stream as the background image when the video stream is intra-coded, it is possible to update the background image efficiently.

Furthermore, by receiving background information indicating the positions of the background area corresponding to the video stream and the non-background area, combining the image of the non-background area and prestored background image according to the received background information, that is, combining images according to the received background information, it is possible to accurately combine the prestored background image and the image of the non-background area.

Furthermore, by discriminating the area where a difference value obtained by carrying out difference processing between the base layer decoded image obtained through decoding from the received video stream and the background image which has been decoded from the received video stream and prestored is equal to or lower than a predetermined threshold as the background area and the area other than the background area as the non-background area, and combining the non-background area decoded image obtained through decoding the non-background area and the prestored background image, it is possible to discriminate between the background area and the non-background area based on the prestored background image and the base layer decoded image even if the coding side does not send the background information indicating the positions of the background area and the non-background area, reduce the amount of data transmitted from the coding side to the decoding side by the amount of the background information and improve the coding efficiency.

Furthermore, by receiving information on a background motion vector which is a value obtained by accumulating motion vector averages in response to the video stream and the combiner moving the prestored background image according to the background motion vector and then combining the background image with the image of the non-background area, that is, receiving the information on the background motion vector and moving the background image according to the background motion vector and then combining the images, it is possible to accurately move the background image by the amount of movement of the entire image even if the transmitting side of the video stream is panning, for example.

Furthermore, the video communication method according to an embodiment of the present invention includes a step of separating an input image into a background area and a non-background area, a step of coding only the separated non-background area and a step of transmitting the video stream of the non-background area obtained through coding, that is, separating an input image into a background area and a non-background area and coding and sending only the non-background area, and can thereby reduce the amount of data to be coded and improve the coding efficiency while suppressing the processing load. Furthermore, by the video stream receiving side combining the prestored background image with the image of the non-background area, it is possible to obtain a correct decoded image and prevent drift noise without being affected by variations in the amount of data received.

Furthermore, the video communication method according to an embodiment of the present invention includes a step of receiving a video stream of a non-background area, a step of decoding the received video stream and a step of combining the image of the non-background area obtained through decoding with a prestored background image, that is, decoding the video stream of the received non-background area and combining the image with a prestored background image, and can thereby obtain a correct decoded image and prevent drift noise without being affected by variations in the amount of data received.

Therefore, the video communication apparatus and video communication method according to the present invention can improve the coding efficiency while suppressing the processing load without producing drift noise, and can be effectively used for a surveillance camera system, etc., which requires a low-delay and high-quality video transmission.

The present invention is not limited to the above described embodiments, and various variations and modifications may be possible without departing from the scope of the present invention.

This application is based on the Japanese Patent Application No. 2004-033588 filed on Feb. 10, 2004, and No. 2004-340972 filed on Nov. 25, 2004 entire content of which is expressly incorporated by reference herein.

[FIG. 1]

100 VIDEO TRANSMISSION APPARATUS
110 VIDEO INPUT
130 BASE LAYER CODER
131 MOTION COMPENSATOR
132 QUANTIZER
133 VARIABLE LENGTH CODER
160 VIDEO TRANSMITTER
120 BACKGROUND SEPARATOR
150 BASE LAYER DECODER
141 ERROR PROCESSOR
142 ORTHOGONAL TRANSFORMER
143 VARIABLE LENGTH CODER
170 VIDEO TRANSMITTER
140 ENHANCEMENT LAYER CODER
   [FIG. 2]
300 VIDEO RECEPTION APPARATUS
310 VIDEO RECEIVER
330 BASE LAYER DECODER
331 VARIABLE LENGTH DECODER
332 INVERSE QUANTIZER
333 MOTION COMPENSATOR
320 VIDEO RECEIVER
341 VARIABLE LENGTH DECODER
342 ORTHOGONAL TRANSFORMER
343 ADDITION PROCESSOR
350 BACKGROUND COMBINER
360 VIDEO DISPLAY SECTION
340 ENHANCEMENT LAYER DECODER
   [FIG. 3]
START
ST1000 VIDEO INPUT
ST1050 DECISION OF CODING MODE
ST1100 MOTION PREDICTION/COMPENSATION
ST1150 ORTHOGONAL TRANSFORM/QUANTIZATION
ST1200 VARIABLE LENGTH CODING
ST1250 BASE LAYER DECODING
ST1300 BACKGROUND DISCRIMINATION PROCESSING
ST1350 IMAGE DIFFERENCE PROCESSING
ST1400 ORTHOGONAL TRANSFORM
ST1450 VARIABLE LENGTH CODING
ST1500 VIDEO TRANSMISSION
ST1550 COMPLETED?
END
   [FIG. 4]
BACKGROUND DISCRIMINATION PROCESSING
ST1302 CODIGN MODE=INTRA-CODING?
ST1304 CALCUALTION OF BACKGROUND AREA
ST1306 NON-BACKGROUND MAP UPDATING
ST1308 BACKGROUND IMAGE UPDATING
ST1310 BACKGROUND SEPARATION
ST1312 GENERATION OF BACKGROUND INFORMATION
RETURN
   [FIG. 8]
START
ST2000 VIDEO RECEPTION
ST2050 VARIABLE LENGTH DECODING
ST2100 INVERSE ORTHOGONAL TRANSFORM/INVERSE QUANTIZATION
ST2150 MOTION COMPENSATION DECODING
ST2200 VARIABLE LENGTH DECODING
ST2250 ORTHOGONAL TRANSFORM
ST2300 IMAGE ADDITION PROCESSING
ST2350 BACKGROUND COMBINATION PROCESSING
ST2400 VIDEO DISPLAY
END
   [FIG. 9]
BACKGROUND COMBINATION PROCESSING
ST2352 CODING MODE=INTRA-CODING?
ST2354 BACKGROUND COMBINATION
ST2356 BACKGROUND STORAGE
RETURN
   [FIG. 11]
500 VIDEO TRANSMISSION APPARATUS
110 VIDEO INPUT
130 BASE LAYER CODER
131 MOTION COMPENSATOR
132 QUANTIZER
133 VARIABLE LENGTH CODER
160 VIDEO TRANSMITTER
120a BACKGROUND SEPARATOR
510 MOVEMENT DETECTOR
150 BASE LAYER DECODER
141 ERROR PROCESSOR
142 ORTHOGONAL TRANSFORMER
143 VARIABLE LENGTH CODER
170 VIDEO TRANSMITTER
140 ENHANCEMENT LAYER CODER
   [FIG. 12]
600 VIDEO RECEPTION APPARATUS
310 VIDEO RECEIVER
330 BASE LAYER DECODER
331 VARIABLE LENGTH DECODER
332 INVERSE QUANTIZER
333 MOTION COMPENSATOR
320 VIDEO RECEIVER
341 VARIABLE LENGTH DECODER
342 ORTHOGONAL TRANSFORMER
343 ADDITION PROCESSOR
350a BACKGROUND COMBINER
360 VIDEO DISPLAY SECTION
340 ENHANCEMENT LAYER DECODER
   [FIG. 13]
BACKGROUND DISCRIMINATION PROCESSING
ST1302 CODING MODE=INTRA-CODING?
ST3000 MOTION VECTOR INPUT STANDBY
ST3002 BACKGROUND MOVED?
ST3004 BACKGROUND MOVMENT PROCESSING
ST1304 BACKGROUND AREA CALCULATION
ST1306 NON-BACKGROUND MAP UPDATING
ST1308 BACKGROUND IMAGE UPDATING
ST1310 BACKGROUND SEPARATION
ST1312 GENERATION OF BACKGROUND INFORMATION
RETURN
   [FIG. 15]
730 BACKGROUND IMAGE NUMBER=N
BACKGROUND MOTION VECTOR=(MVX, MVY)
   [FIG. 16]
BACKGROUND COMBINATION PROCESSING
ST2352 CODING MODE=INTRA-CODING?
ST4000 BACKGROUND MOVED?
ST4002 BACKGROUND MOVEMENT PROCESSING
ST2354 BACKGROUND COMBINATION
ST2356 BACKGROUND STORAGE
RETURN
   [FIG. 18]
800 VIDEO TRANSMISSION APPARATUS
110 VIDEO INPUT
130 BASE LAYER CODER
131 MOTION COMPENSATOR
132 QUANTIZER
133 VARIABLE LENGTH CODER
160 VIDEO TRANSMITTER
820 BACKGROUND SEPARATOR
850 BASE LAYER DECODER
141 ERROR PROCESSOR
142 ORTHOGONAL TRANSFORMER
143 VARIABLE LENGTH CODER
170 VIDEO TRANSMITTER
140 ENHANCEMENT LAYER CODER
   [FIG. 19]
900 VIDEO RECEPTION APPARATUS
933 MOTION COMPENSATOR
332 INVERSE QUANTIZER
331 VARIABLE LENGTH DECODER
310 VIDEO RECEIVER
330 BASE LAYER DECODER
360 VIDEO DISPLAY SECTION
350 BACKGROUND COMBINER
343 ADDITION PROCESSOR
342 ORTHOGONAL TRANSFORMER
341 VARIABLE LENGTH DECODER
320 VIDEO RECEIVER
340 ENHANCEMENT LAYER DECODER
   [FIG. 20]
START
ST1000 VIDEO INPUT
ST1050 DECISION OF CODING MODE
ST1100 MOTION PREDICTION/COMPENSATION
ST1150 ORTHOGONAL TRANSFORM/QUANTIZATION
ST1200 VARIABLE LENGTH CODING
ST1250 BASE LAYER DECODING
ST1255 BACKGROUND DISCRIMINATION PROCESSING
ST1350 IMAGE DIFFERENCE PROCESSING
ST1400 ORTHOGONAL TRANSFORM
ST1450 VARIABLE LENGTH CODING
ST1500 VIDEO TRANSMISSION
ST1550 COMPLETED?
END
   [FIG. 21]
BACKGROUND DISCRIMINATION/SEPARATION PROCESSING
ST1302 CODIGN MODE=INTRA-CODING?
ST1305 CALCUALTION OF BACKGROUND AREA
ST1306 NON-BACKGROUND MAP UPDATING
ST1308 BACKGROUND IMAGE UPDATING
ST1310 BACKGROUND SEPARATION
RETURN
   [FIG. 22]
START
ST2000 VIDEO RECEPTION
ST2050 VARIABLE LENGTH DECODING
ST2100 INVERSE ORTHOGONAL TRANSFORM/INVERSE QUANTIZATION
ST2150 MOTION COMPENSATION DECODING
ST2200 VARIABLE LENGTH DECODING
ST2250 ORTHOGONAL TRANSFORM
ST2300 IMAGE ADDITION PROCESSING
ST2350 BACKGROUND COMBINATION PROCESSING
ST2400 VIDEO DISPLAY
END
   [FIG. 23]
BACKGROUND COMBINATION PROCESSING
ST2352 CODING MODE=INTRA-CODING?
ST2357 BACKGROUND COMBINATION PROCESSING
ST2359 BACKGROUND STORAGE PROCESSING
RETURN

1. A video communication apparatus comprising:
a separator separates an input image into a background area and a non-background area;
a coder codes the separated non-background area; and
a transmitter transmits a video stream of the non-background area obtained through coding.

2. The video communication apparatus according to claim 1, wherein said coder comprises:
a base layer coder codes the entire area of the input image in a base layer; and
a non-background area coder codes the non-background area included in the input image in an enhancement layer, and
said transmitter transmits the video stream of the coded base layer and the video stream of the coded enhancement layer.

3. The video communication apparatus according to claim 1, wherein said separator regards the area where a difference value obtained by carrying out difference processing between the background image stored as a preceding input image and the input image this time is equal to or lower than a predetermined threshold as a background area and the area other than said background area as a non-background area.

4. The video communication apparatus according to claim 1, wherein said separator regards the area where a difference value obtained by carrying out difference processing between the background image stored as a coded and decoded preceding input image and an input image this time is equal to or lower than a predetermined threshold as a background area and the area other than said background area as a non-background area.

5. The video communication apparatus according to claim 2, wherein said separator regards the area where a difference value obtained by carrying out difference processing between the background image stored as the entire area of a preceding input image coded and decoded in a base layer and a base layer decoded image obtained by coding and decoding the entire area of an input image this time in the base layer is equal to or lower than a predetermined threshold as a background area and the area other than said background area as a non-background area.

6. The video communication apparatus according to claim 1, wherein said separator separates an input image into a background area and a non-background area using a background image having the highest correlation with the input image this time out of a plurality of background images stored as the coded and decoded input image.

7. The video communication apparatus according to claim 1, wherein said separator separates an input image into a background area and a non-background area using a background image having the highest correlation with a base layer decoded image obtained through coding and decoding the entire area of the input image this time out of a plurality of background images stored as the entire area of the input image coded and decoded in the base layer.

8. The video communication apparatus according to claim 1, wherein said separator separates an input image into a background area and a non-background area using a macro block made up of a predetermined number of pixels.

9. The video communication apparatus according to claim 1, wherein said separator generates, when the proportion of the non-background area in the input image is equal to or greater than a predetermined threshold, coding mode information that intra-coding without using a correlation with other frames of the input image should be performed and outputs the coding mode information generated to said coder,
said coder performs said intra-coding on the entire area of the input image according to said coding mode information and stores said input image as a background image, and
said transmitter transmits said intra-coded input image and said coding mode information.

10. The video communication apparatus according to claim 1, wherein said separator generates, when the proportion of the non-background area in the input image is equal to or greater than a predetermined threshold, coding mode information that intra-coding without using a correlation with other frames of the input image should be performed and outputs the coding mode information generated to said coder,
said coder performs said intra-coding and said intra-decoding on the entire area of the input image according to said coding mode information and stores the intra-decoded input image as a background image, and
said transmitter transmits said intra-coded input image and said coding mode information.

11. The video communication apparatus according to claim 2, wherein said separator generates, when the proportion of the non-background area in the input image is equal to or greater than a predetermined threshold, coding mode information that intra-coding without using a correlation with other frames of the input image should be performed and outputs the coding mode information generated to said coder,
said base layer coder performs said intra-coding and said intra-decoding on the entire area of an input image according to said coding mode information and stores the intra-decoded input image as background image, and
said transmitter transmits said intra-coded input image and said coding mode information.

12. The video communication apparatus according to claim 1, wherein said separator generates, when the proportion of the non-background area in the input image is equal to or greater than a predetermined threshold, coding mode information that intra-coding without using a correlation with other frames of the input image should be performed and outputs the coding mode information generated to said coder,
said coder further performs said intra-coding on the entire area of the input image according to said coding mode information and stores the decoded image generated by intra-decoding said intra-coded input image as the background image, and
said transmitter transmits said intra-coded input image and said coding mode information.

13. The video communication apparatus according to claim 2, wherein said separator generates, when the proportion of the non-background area in the input image is equal to or greater than a predetermined threshold, coding mode information that intra-coding without using a correlation with other frames of the input image should be performed and outputs the coding mode information generated to said coder,
said base layer coder performs said intra-coding on the entire area of an input image in the base layer according to said coding mode information and stores the decoded image generated by intra-decoding said intra-coded input image as a background image, and
said transmitter transmits said intra-coded input image and said coding mode information.

14. The video communication apparatus according to claim 1, wherein said separator generates background information indicating the positions of the background area and non-background area in the input image, and
said transmitter transmits said background information together with said video stream.

15. The video communication apparatus according to claim 4, further comprising a movement detector that detects movement of the entire image of the input image,
wherein said separator carries out difference processing from the input image after moving a prestored background image by the amount of movement of said entire image.

16. The video communication apparatus according to claim 15, wherein said movement detector decides, when a variance among motion vectors of the entire image calculated by said coder is equal to or lower than a predetermined threshold, that the entire image is moving.

17. The video communication apparatus according to claim 14, wherein said movement detector obtains a background motion vector which is a value accumulating said motion vector averages of previous frames, and
said separator carries out difference processing from the input image after moving a prestored background image according to said background motion vector.

18. A video communication apparatus comprising:
a receiver receives a video stream of a non-background area;
a decoder decodes the received video stream; and
a combiner combines an image of the non-background area obtained through decoding from the received video stream and a prestored background image.

19. A video communication apparatus comprising:
a receiver receives a video stream of a non-background area;
a decoder decodes the received video stream; and
a combiner discriminates between a background area and a non-background area based on a base layer decoded image obtained from the received video stream through decoding and a background image decoded from the received video stream and prestored and combines the image of the non-background area obtained through decoding and the background area of the prestored background image based on the discrimination result.

20. The video communication apparatus according to claim 18, wherein said receiver receives a video stream of a base layer related to the entire area of an image and a video stream of an enhancement layer related to only the non-background area of the image, and
said decoder comprises:
a base layer decoder decodes the video stream of the base layer; and
an enhancement layer decoder decodes the video stream of the enhancement layer.

21. The video communication apparatus according to claim 18, wherein said receiver receives coding mode information indicating that said video stream is intra-coded, and
said combiner stores a decoded image of an intra-coded video stream as a background image.

22. The video communication apparatus according to claim 18, wherein said receiver receives background information indicating the positions of a background area and a non-background area corresponding to said video stream, and
said combiner combines the image of the non-background area and prestored background image according to the received background information.

23. The video communication apparatus according to claim 19, wherein said combiner discriminates an area where a difference value calculated through difference processing between a base layer decoded image obtained through decoding from the received video stream and the background image which has been decoded from the received video stream and prestored is equal to or lower than a predetermined threshold as a background area and the area other than said background area as a non-background area and combines the non-background area decoded image obtained through decoding the non-background area and the prestored background image.

24. The video communication apparatus according to claim 18, wherein said receiver receives information on a background motion vector which corresponds to said video stream and which is a value obtained by accumulating motion vector averages, and
said combiner moves the prestored background image according to said background motion vector and then combines the background image with the image of the non-background area.

25. A video communication method comprising the steps of:
separating an input image into a background area and a non-background area;
coding only the separated non-background area; and
transmitting a video stream of the non-background area obtained through coding.

26. A video communication method comprising the steps of:
receiving a video stream of a non-background area;
decoding the received video stream; and
combining the image of the non-background area obtained through decoding and a prestored background image.
